(19) United States
(12) Patent Application Publication
(10) Pub. No.: US 2012/0000754 A1
(43) Pub. Date: Jan. 5, 2012

(54) SWITCH

(75) Inventors: Abe Takayuki, Kurayoshi-shi (JP); Kenichi Ando, Okayama-shi (JP); Shigenobu Kishi, Ritto-shi (JP); Yuya Kudo, Kurayoshi-shi (JP)

(73) Assignee: OMRON CORPORATION, Kyoto-shi (JP)

(21) Appl. No.: 13/173,665

(22) Filed: Jun. 30, 2011

(30) Foreign Application Priority Data
Jul. 5, 2010 (JP) 2010-153033
Feb. 8, 2011 (JP) 2011-024625

(51) Int. Cl. H01H 1/50

(52) U.S. Cl. 200/290

(57) ABSTRACT

A switch has a housing, a contact mechanism having a movable contact piece disposed in the housing, an operating element that operates the movable contact piece, a spring member of the contact mechanism that operates the movable contact piece to open and close a contact, and a regulating mechanism that suppresses vibration of the spring member arranged at a position contacting the spring member.

### BACKGROUND OF THE INVENTION

1. Technical Field

The present invention relates to switches, and in particular, to a micro-switch capable of inhibiting the occurrence of resonance phenomenon and preventing false operation.

2. Related Art

Conventionally, the switch may be a brake lever interlocking switch including a switch case, a swing plate attached to the switch case to swing interlocking with the brake lever, a plurality of push rods that is attached to the switch case to push down with the swing plate and that has different distances from the center of rotation of the swing plate, and a switch means facing such push rods (see Japanese Unexamined Patent Publication No. 10-297364)

### SUMMARY

In the above-described switch, however, the amplitude of a spring 99 or a spring member increases by the vibration generated when opening and closing the contact or the impact force applied from the outside, and the resonance phenomenon tends to easily occur, as shown in FIG. 8 thereof. When the resonance phenomenon occurs, not only does false operation occur, but the spring member easily breaks, the contact wears, and the contact lifespan becomes short.

One or more embodiments of the present invention provides a switch capable of inhibiting the occurrence of the resonance phenomenon caused by the increase of the amplitude of the spring member and preventing false operation, and furthermore, preventing the breakage of the spring member and realizing long contact lifespan.

In accordance with one or more embodiments of the present invention, there is provided a switch in which a movable contact piece of a contact mechanism arranged in a housing is operated with an operating element, and the movable contact piece is operated with a spring member of the contact mechanism to open and close a contact; wherein a regulating means for suppressing vibration of the spring member is arranged at a position of contacting the spring member. Especially, the regulating means may be arranged to be brought into contact with the spring member at time of resonance.

According to one or more embodiments of the present invention, when the contact mechanism is operated with the operating element or when the impact force is applied from the outside, the spring member is not brought into contact with the regulating means if the spring member is not vibrating, whereas the spring member is brought into contact with the regulating means if the spring member is vibrating, particularly, if the spring member starts to vibrate. As a result, the regulating means shifts the timing to increase the amplitude of the spring member so that the amplitude of the spring member does not increase and the resonance phenomenon can be inhibited. Therefore, the false operation can be prevented, and furthermore, the breakage of the spring member can be prevented and the wear of the contact can be reduced so that a switch of longer contact lifespan can be realized.

In one or more embodiments of the present invention, the spring member may be a coil member.

Accordingly, a switch having a large degree of freedom of design can be realized since the elastic displacement amount of the coil spring is large.

In one or more embodiments of the present invention, the spring member may be a plate spring integral with the movable contact piece.

Accordingly, a switch with less number of components and number of assembly steps and with high productivity can be obtained.

In one or more embodiments of the present invention, the spring member may be a plate spring of a separate body from the movable contact piece.

Accordingly, a switch having a large degree of freedom of design can be realized by using the plate spring of a separate body.

In one or more embodiments of the present invention, the regulating means may be a tongue piece cutout from a terminal of the contact mechanism.

Accordingly, a switch with less number of components and number of assembly steps and with high productivity can be obtained.

In one or more embodiments of the present invention, the regulating means may be a projection arranged in a projecting manner on the inner surface of the housing or a bulging portion bulging out from the inner surface of the housing.

Accordingly, a switch with high productivity can be obtained by integrally molding the regulating means at the same time as the housing.

The projection or the bulging portion may be assembled after being molded separate from the housing rather than being integrally molded on the inner surface of the housing.

### BRIEF DESCRIPTION OF THE DRAWINGS

FIGS. 1A, 1B, and 1C are perspective views showing a switch according to a first embodiment of the present invention;

FIG. 2 is an exploded perspective view of the switch shown in FIG. 1B;

FIG. 3 is an exploded perspective view of the switch shown in FIG. 1C;

FIGS. 4A and 4B are perspective views showing a contact mechanism of the switch shown in FIGS. 1A to 1C;

FIGS. 5A, 5B, and 5C are a front view describing the operation process, a cross-sectional view cut at a position of removing only the side wall on the front surface side of the housing, and a cross-sectional view cut at a position of vertically dividing the operating element in half;

FIGS. 6A, 6B, and 6C are a front view describing the operation process, a cross-sectional view cut at a position of removing only the side wall on the front surface side of the housing, and a cross-sectional view cut at a position of vertically dividing the operating element in half;

FIGS. 7A, 7B, and 7C are a front view describing the operation process, a cross-sectional view cut at a position of removing only the side wall on the front surface side of the housing, and a cross-sectional view cut at a position of vertically dividing the operating element in half;

FIGS. 8A, 8B, and 8C are a front view describing the operation process, a cross-sectional view cut at a position of removing only the side wall on the front surface side of the housing, and a cross-sectional view cut at a position of vertically dividing the operating element in half;

FIGS. 9A and 9B are perspective views showing a switch according to a second embodiment of the present invention;

FIG. 10 is an exploded perspective view of the switch shown in FIG. 9A;

FIG. 11 is an exploded perspective view of the switch shown in FIG. 9B;

FIGS. 12A and 12B are perspective views showing a contact mechanism integrally molded with the base shown in FIGS. 1A to 1C;

FIGS. 13A, 13B, and 13C are a front view describing the operation process, a cross-sectional view cut at a position of removing only the side wall on the front surface side of the housing, and a cross-sectional view cut at a position of vertically dividing the operating element in half;

FIGS. 14A, 14B, and 14C are a front view describing the operation process, a cross-sectional view cut at a position of removing only the side wall on the front surface side of the housing, and a cross-sectional view cut at a position of vertically dividing the operating element in half;

FIGS. 15A, 15B, and 15C are a front view describing the operation process, a cross-sectional view cut at a position of removing only the side wall on the front surface side of the housing, and a cross-sectional view cut at a position of vertically dividing the operating element in half;

FIGS. 16A, 16B, and 16C are a front view describing the operation process, a cross-sectional view cut at a position of removing only the side wall on the front surface side of the housing, and a cross-sectional view cut at a position of vertically dividing the operating element in half;

FIGS. 17A and 17B are perspective views showing a switch according to a third embodiment of the present invention;

FIG. 18 is an exploded perspective view of the switch shown in FIG. 17A;

FIG. 19 is an exploded perspective view in which the switch shown in FIG. 17B is viewed from the lower side;

FIGS. 20A and 20B are perspective views showing a contact mechanism of the switch shown in FIGS. 17A and 17B;

FIGS. 21A, 21B, and 21C are a front view describing the operation process, a cross-sectional view cut at a position of removing only the side wall on the front surface side of the housing, and a cross-sectional view cut at a position of vertically dividing the operating element in half;

FIGS. 22A, 22B, and 22C are a front view describing the operation process, a cross-sectional view cut at a position of removing only the side wall on the front surface side of the housing, and a cross-sectional view cut at a position of vertically dividing the operating element in half;

FIGS. 23A, 23B, and 23C are a front view describing the operation process, a cross-sectional view cut at a position of removing only the side wall on the front surface side of the housing, and a cross-sectional view cut at a position of vertically dividing the operating element in half;

FIGS. 24A, 24B, and 24C are a front view describing the operation process, a cross-sectional view cut at a position of removing only the side wall on the front surface side of the housing, and a cross-sectional view cut at a position of vertically dividing the operating element in half;

FIGS. 25A, 25B, and 25C are perspective views showing a switch according to a fourth embodiment of the present invention;

FIG. 26 is an exploded perspective view in which the switch shown in FIG. 25A is viewed from the lower side;

FIG. 27 is an exploded perspective view of the switch shown in FIG. 25C;

FIGS. 28A and 28B are perspective views showing a contact mechanism of the switch shown in FIGS. 25A, 25B, and 25C;

FIGS. 29A, 29B, and 29C are a front view describing the operation process, a cross-sectional view cut at a position of removing only the side wall on the front surface side of the housing, and a cross-sectional view cut at a position of vertically dividing the operating element in half;

FIGS. 30A, 30B, and 30C are a front view describing the operation process, a cross-sectional view cut at a position of removing only the side wall on the front surface side of the housing, and a cross-sectional view cut at a position of vertically dividing the operating element in half;

FIGS. 31A, 31B, and 31C are a front view describing the operation process, a cross-sectional view cut at a position of removing only the side wall on the front surface side of the housing, and a cross-sectional view cut at a position of vertically dividing the operating element in half;

FIGS. 32A, 32B, and 32C are a front view describing the operation process, a cross-sectional view cut at a position of removing only the side wall on the front surface side of the housing, and a cross-sectional view cut at a position of vertically dividing the operating element in half; and

FIG. 33 is a graph showing the measurement result of the vibration experiment conducted on the first embodiment.

### DETAILED DESCRIPTION

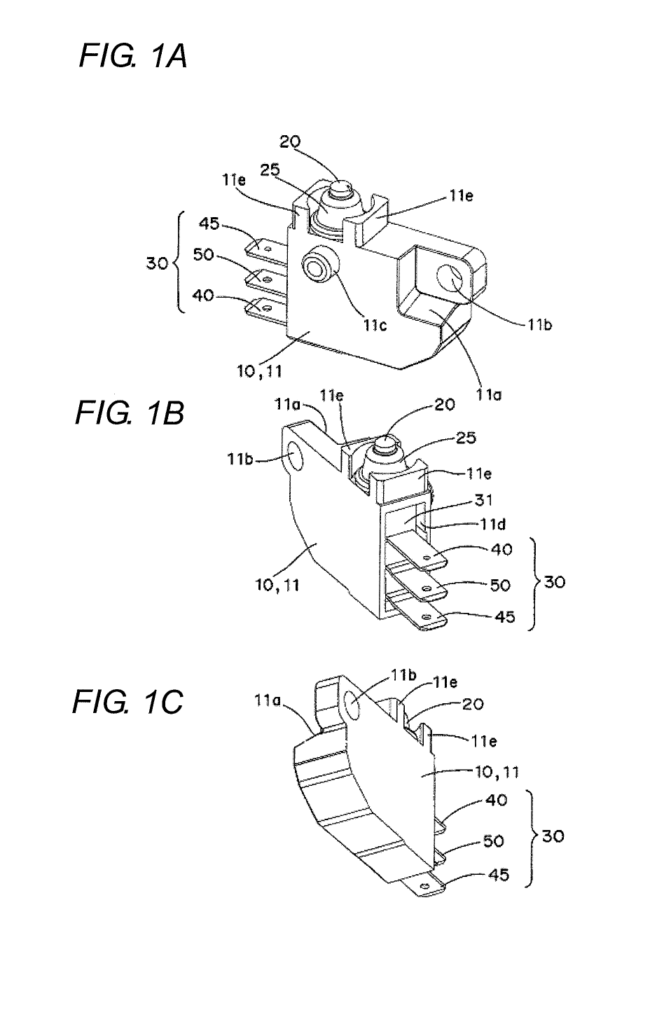

Hereinafter, embodiments of the present invention will be described with reference to the accompanied drawings FIGS. 1A to 1C to FIGS. 32A to 32C. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

As shown in the accompanied drawings FIGS. 1A to 1C to FIGS. 8A to 8C, a switch according to a first embodiment is configured by a housing 10, an operating element 20 attached to the housing 10 through a rubber cap 25, and a contact mechanism 30 assembled to a holder 31 incorporated in the housing 10 from the side and operated by the operating element 20.

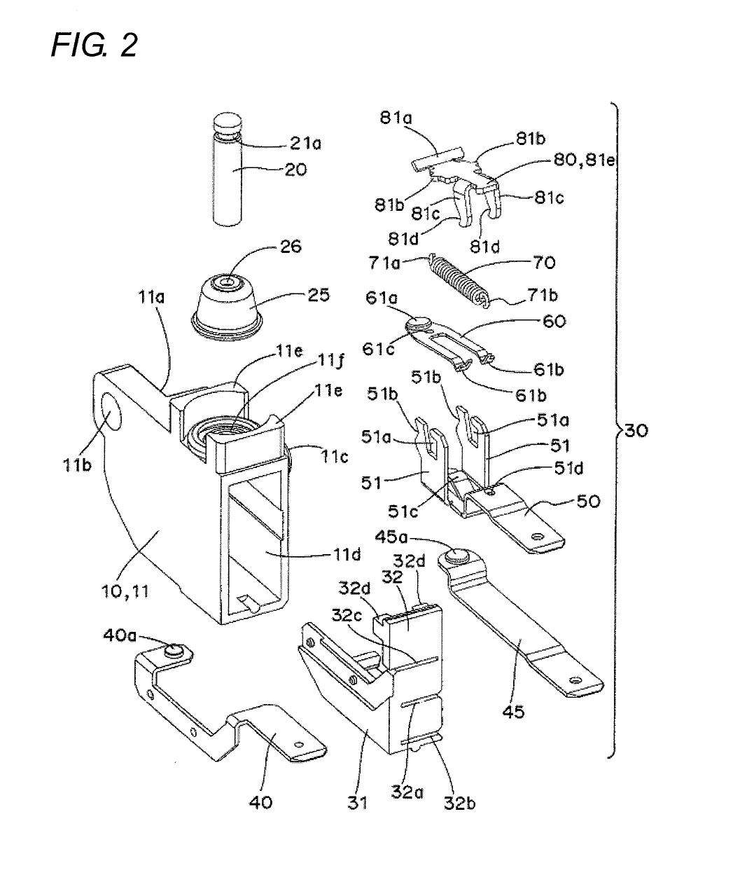

As shown in FIG. 1A, the housing 10 includes an attachment hole 11b at a side surface of a step portion 11a arranged on one side of a one side surface of a housing main body 11, and has a positioning boss 11c arranged in a projecting manner on the other side. As shown in FIG. 1B, the housing main body 11 includes a vertically long assembly opening 11d at the end face on the other side. Furthermore, the housing main body 11 has an operation hole 11f arranged between a pair of protection barriers 11e, 11e arranged in a projecting manner to the other side of the upper end face (FIG. 2).

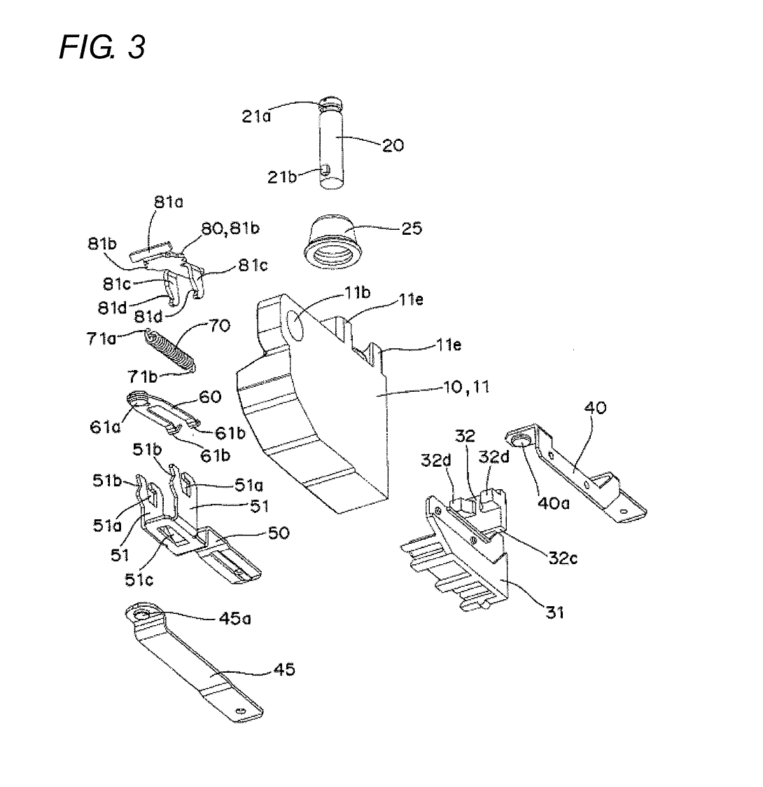

As shown in FIG. 2, the operating element 20 is assembled to the operation hole 11f of the housing 10 so as to be movable up and down by fitting an annular edge of an opening 26 of the rubber cap 25 to an annular groove 21a formed on the upper side. A slip-out preventing projection 21b is projected to the side at the outer peripheral surface on the lower side of the operating element 20 (FIG. 3).

As shown in FIG. 2, the contact mechanism 30 has a common terminal 50 arranged between an always-opened fixed contact terminal 40 and an always-closed fixed contact terminal 45 assembled to the holder 31. An always-opened fixed contact 40a and an always-closed fixed contact 45a are respectively arranged at one end of the always-opened fixed contact terminal 40 and the always-closed fixed contact terminal 45. A movable contact piece 60, a coil spring 70 serving as a spring member, and an operation piece 80 are assembled to the common terminal 50.

The holder 31 has an outer peripheral shape that can be inserted from an assembly opening 11d of the housing 10, and has press-fit slits 32a, 32b, 32c alternately arranged in a zigzag manner on a vertical wall 32. A pair of guide projections 32d, 32d is arranged on an inward surface of the vertical wall 32 to position regulate the operating element 20, to be described later.

The common terminal 50 has a pair of raised pieces 51, 51 formed by cutting and raising both side edges on one side. The raised piece 51 has a cutout 51a formed at the upper end and has a lock receiving portion 51b formed at the outward edge of the raised piece 51. The common terminal 50 has a tongue piece 51c cut and raised between the raised pieces 51. Furthermore, the common terminal 50 includes a lock hole 51d in the vicinity of the tongue piece 51c.

The tongue piece 51c prevents resonance of the coil spring 70 by bringing a bent portion formed by bending the distal end edge to the lower side into contact with the lower surface of the coil spring 70 to be described later. The bent portion may have a shape that not only point contacts the coil spring 70, but also line contacts or area contacts thereto. In particular, if configured to line contact or area contact, the coil spring 70 can be reliably brought into contact with the bent portion even if the dimensional accuracy and the assembly accuracy of the components vary, so that the amplification of the amplitude of the coil spring 70 can be more reliably prevented.

The movable contact piece 60 is a conductive plate spring having a substantially U-shape, where a movable contact 61a is arranged at one end and a lock portion 61b that becomes a supporting point of turn is formed at both ends on the other end side. The movable contact piece 60 also includes a lock hole 61c in the vicinity of the movable contact 61a.

The coil spring 70 has one end 71a lockable to the lock hole 61c of the movable contact piece 60 and the other end 71b lockable to the lock hole 51d of the common terminal 50.

The operation piece 80 has an engagement shaft portion 81a formed along the edge on one side, and a slip-out preventing projection 81b that engages the cutout 51a of the raised piece 51 arranged to project to the side at both side edges of the intermediate portion. The operation piece 80 has a lock receiving portion 81d arranged at a distal end of an arm portion 81c bent down from both side edges on the other side, and has the other end serving as an operation receiving portion 81e.

The assembly method of the switch according to the first embodiment will now be described.

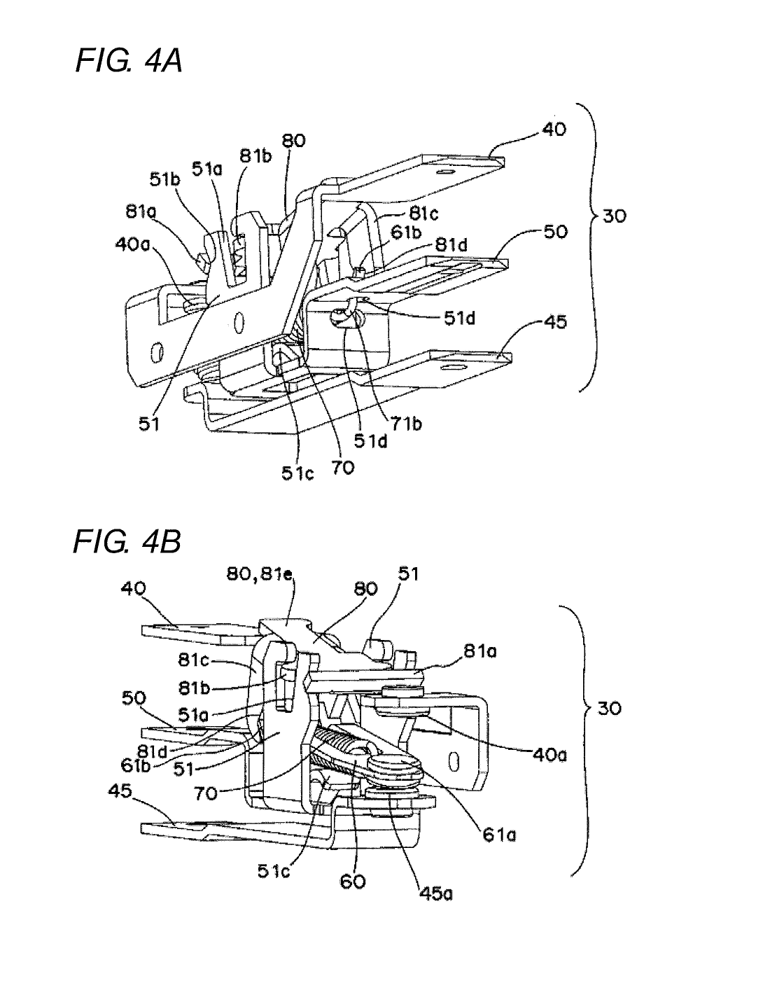

First, the one end 71a of the coil spring 70 shown in FIG. 2 is locked to the lock hole 61c of the movable contact piece 60, and the other end 71b is locked to the lock hole 51d of the common terminal 50. As shown in FIG. 4A and FIG. 4B, the slip-out preventing projection 81b of the operation piece 80 is engaged to the cutout 51a of the common terminal 50, and thereafter the engagement shaft portion 81a of the operation piece 80 is engaged to the lock receiving portion 51b of the common terminal 50 and the lock portion 61b of the movable contact piece 60 is locked to lock receiving portion 81d formed in the arm portion 81c. The movable contact piece 60 is thereby biased towards the lower side by the spring force of the coil spring 70.

Furthermore, the common terminal 50 shown in FIG. 2 is press fit and positioned in the slit 32a of the holder 31, and the always-closed fixed contact terminal 45, the always-opened fixed contact terminal 40 are press fit to the slits 32b, 32c, respectively. The movable contact 61a faces the always-closed fixed contact 45a and the always-opened fixed contact 40a so as to approach or separate thereto.

After inserting the holder 31 from the opening 11d of the housing 10, it is shielded with a resin mold. The opening edge on the lower side of the rubber cap 25 is fitted and thermally caulked to the opening edge of the operation hole 11f of the housing 10, and then the operating element 20 is press fit from the opening 26 of the rubber cap 25 and the opening edge of the rubber cap 25 is elastically fitted and sealed to the annular groove 21a of the operating element 20.

The operation method of the switch will now be described.

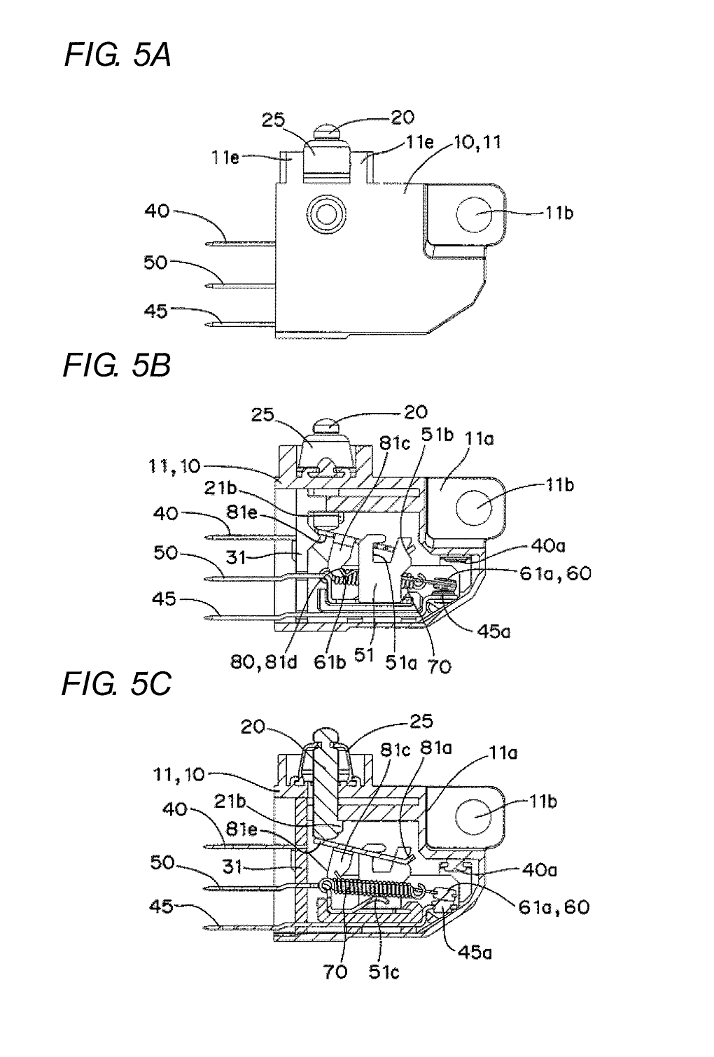

First, as shown in FIGS. 5A to 5C, the operation receiving portion 81e of the operation piece 80 is biased to the upper side by the spring force of the coil spring 70 and the operating element 20 is also biased to the upper side in the no-load state. However, the operating element 20 does not slip out since the slip-out preventing projection 21b is locked to the top surface of the housing 10. The movable contact 61a is brought into contact with the always-closed fixed contact 45a and separated from the always-opened fixed contact 40a.

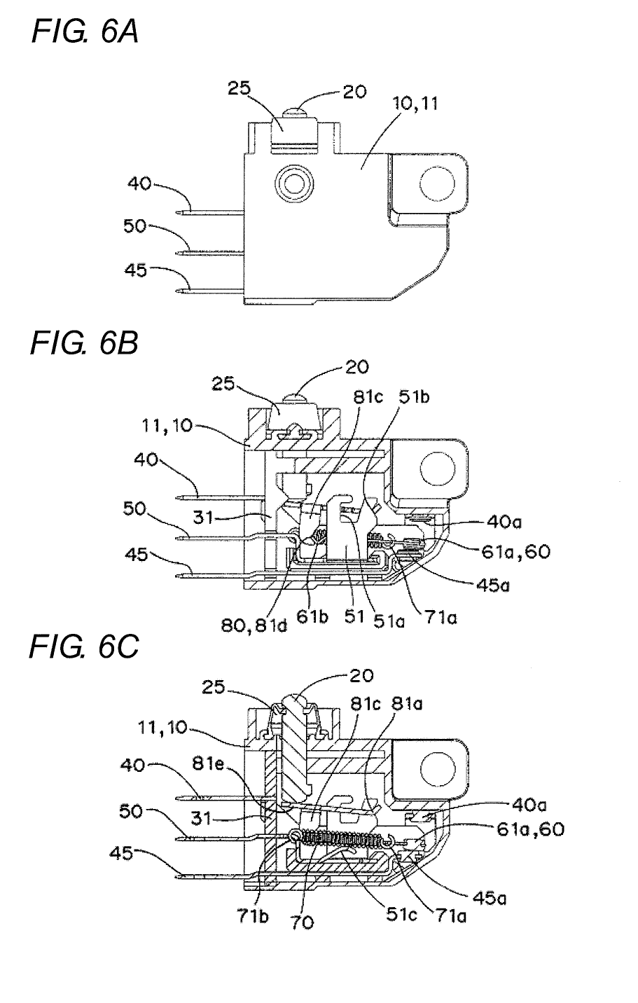

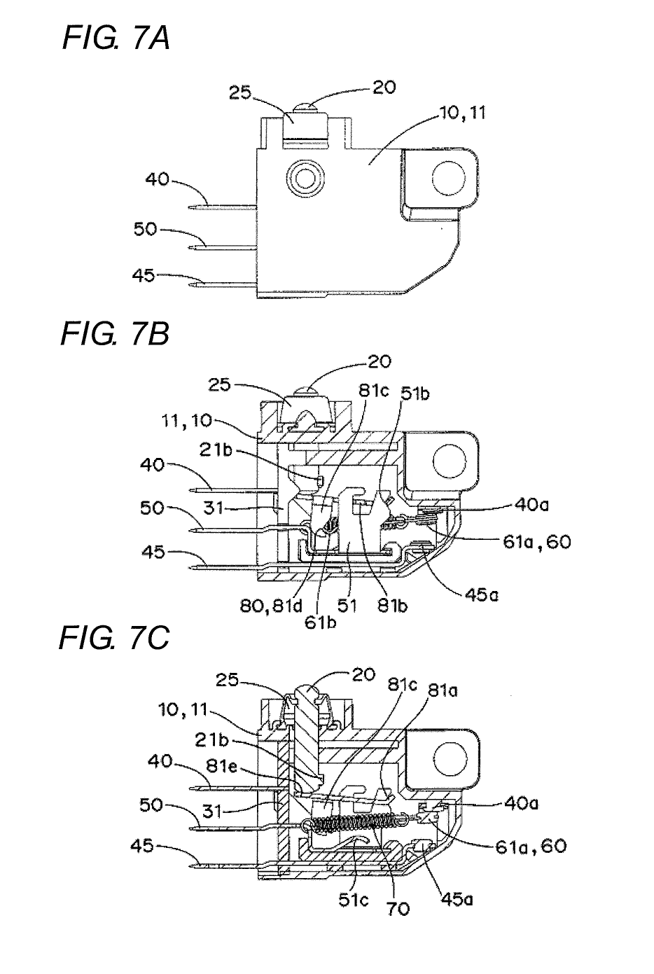

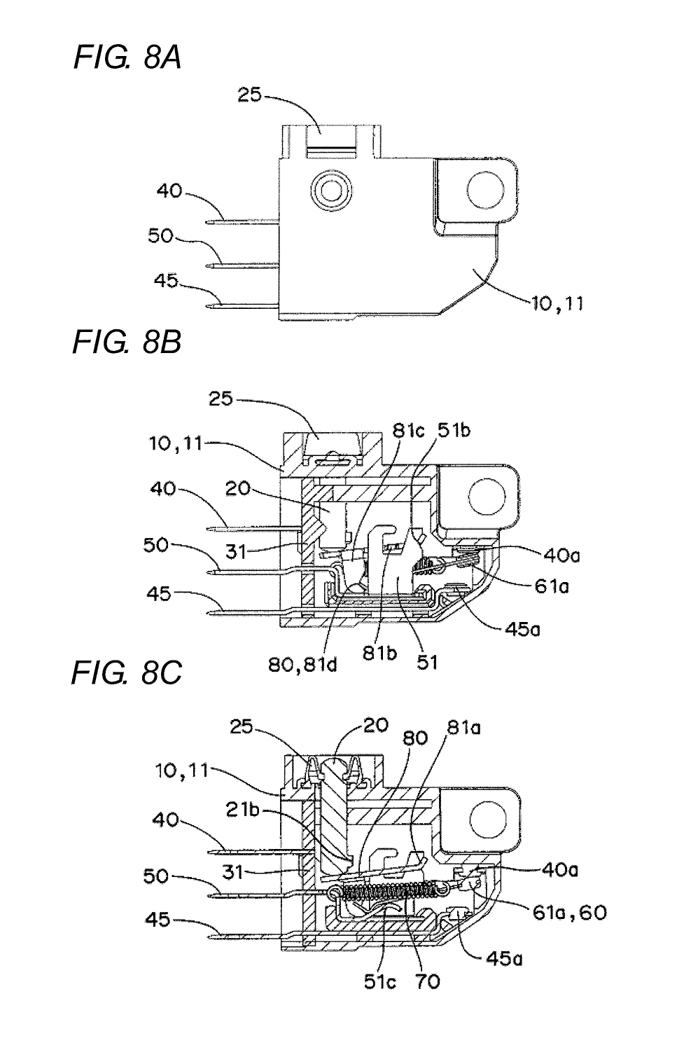

As shown in FIGS. 6A to 6C, when the operation receiving portion 81e of the operation piece 80 is pushed down with the operating element 20, the engagement shaft portion 81a of the operation piece 80 turns with the lock receiving portion 51b of the raised piece 51 as the supporting point. When the lock receiving portion 81d of the operation piece 80 goes over the reference line (not shown) connecting both ends 71a, 71b of the coil spring 70, the movable contact piece 60 is inverted and the movable contact 61a is switched from the always-closed fixed contact 45a to the always-opened fixed contact 40a (FIGS. 7A to 7C). Furthermore, when the operating element 20 is pushed down, the movable contact 61a is brought into contact with the always-opened fixed contact 40 at a predetermined contact pressure (FIGS. 8A to 8C).

When the pushing force with respect to the operating element 20 is released, the movable contact piece 60 is turned in the reverse direction with the spring force of the coil spring 70, and the operating element 20 is pushed to the upper side. Thus, the movable contact 61a is switched from the always-opened fixed contact 40a to the always-closed fixed contact 45a to return to the original position. The operating element 20 does not move out from the housing 10 since the slip-out preventing projection 21b locks to the top surface of the housing 10.

In the course of operation, the vibration occurs by the extension and contraction of the coil spring 70 when the movable contact piece 60 is turned, where the tongue piece 51c arranged on the common terminal 50 is brought into contact with the coil spring 70 thus shifting the timing of increasing the amplitude and preventing the resonance phenomenon.

Similarly, the resonance phenomenon caused by the increase of the amplitude can be prevented even if an impact force is applied from the outside since the coil spring 70 is brought into contact with the tongue piece 51c.

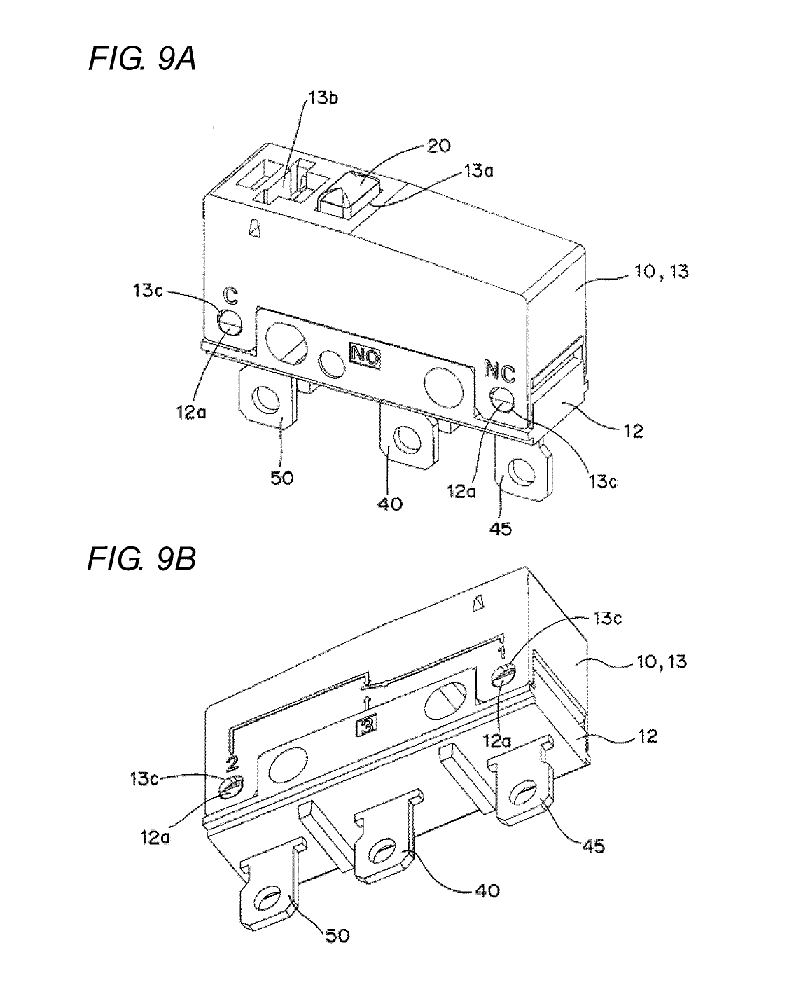

As shown in FIGS. 9A and 9B to FIGS. 16A to 16C, the switch according to a second embodiment is configured by the housing 10, the operating element 20 attached to the housing 10, and the contact mechanism 30 incorporated in the housing 10 and operated by the operating element 20.

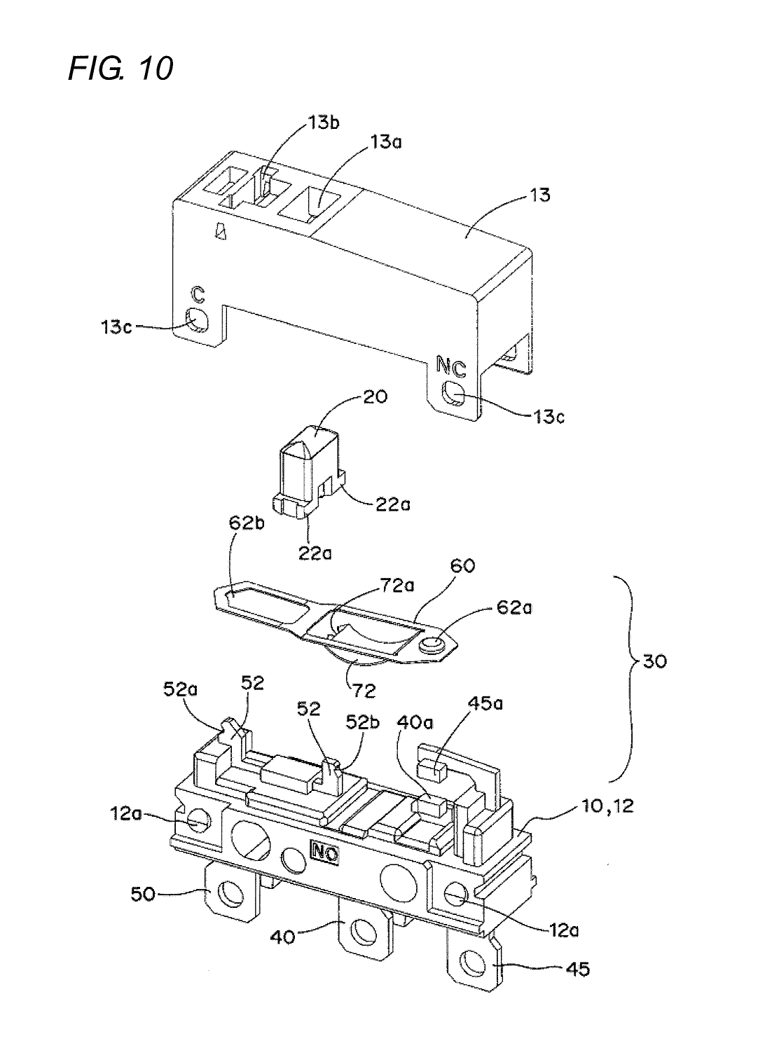

As shown in FIG. 10, the housing 10 is configured by a base 12 in which the always-opened fixed contact terminal 40, the always-closed fixed contact terminal 45, and the common terminal 50 are insert molded, and a cover 13 having a planar shape that can be fitted to the base 12. The contact mechanism 30 is configured by the always-opened fixed contact terminal 40, the always-closed fixed contact terminal 45, the common terminal 50, and the movable contact piece 60, to be described later.

The base 12 has the always-opened fixed contact terminal 40 and the always-closed fixed contact terminal 45 projected from the upper surface, where the always-opened fixed contact 40a and the always-closed fixed contact 45a are respectively arranged at the upper end, the always-opened fixed contact 40a and the always-closed fixed contact 45a being faced to each other. The base has a pair of projection pieces 52, 52 of the common terminal 50 projecting out at the upper surface, where lock receiving portions 52a, 52b are arranged at the outer side edge of the projection pieces 52, 52. Furthermore, the base 12 has an engagement nail portion 12a formed on both side surfaces facing each other.

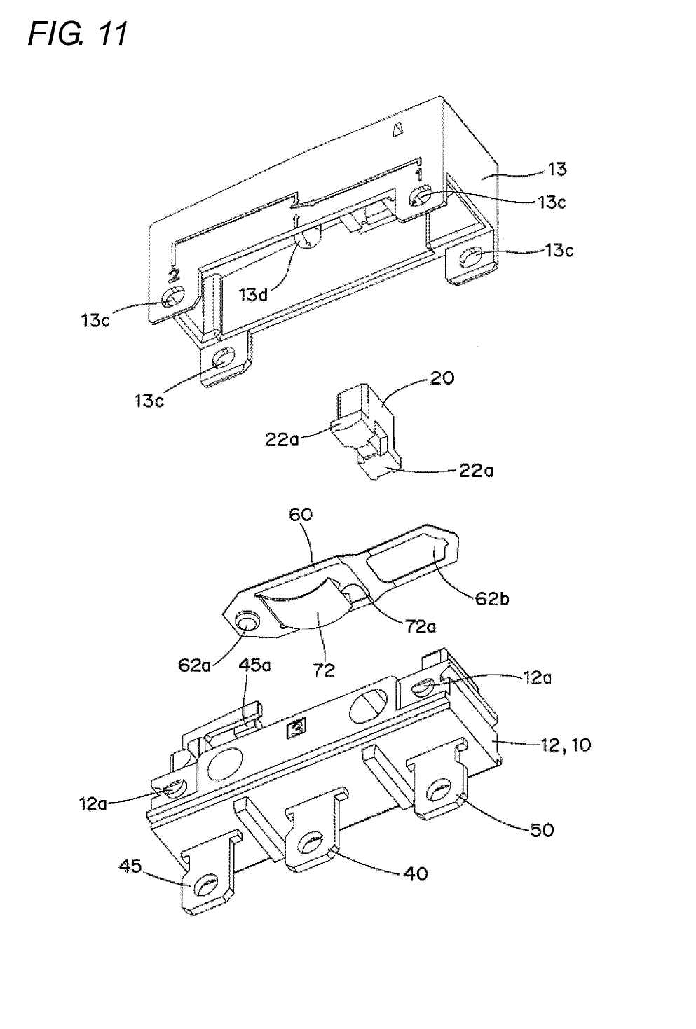

The cover 13 has a recessed area 13b for attaching the operation lever (not shown) formed in the vicinity of the operation hole 13a formed at the upper surface. The cover 13 has an engagement hole 13c formed at the corner on the lower side of the opposing side surface. Moreover, as shown in FIG. 11, the cover 13 has a projection 13d for position regulating a plate spring 72, to be described later, arranged in a projecting manner at the top surface.

As shown in FIG. 10, the movable contact piece 60 configuring the contact mechanism 30 is formed by performing press work on a conductive plate spring material, where a movable contact 62a is arranged on the end on the near side, and a fit-in hole 62b is formed on the far side. Furthermore, an arcuate plate spring 72 performed with bending work is cut out between the movable contact 62a and the fit-in hole 62b. A lock portion 72a is arranged at the free end of the plate spring 72.

The operating element 20 has a planar shape that can be fitted to the operation hole 13a of the cover 13, and has a pair of slip-out preventing projections 22a, 22a arranged in a projecting manner to the side at the lower end.

The assembly method according to one or more embodiments of the present invention will now be described.

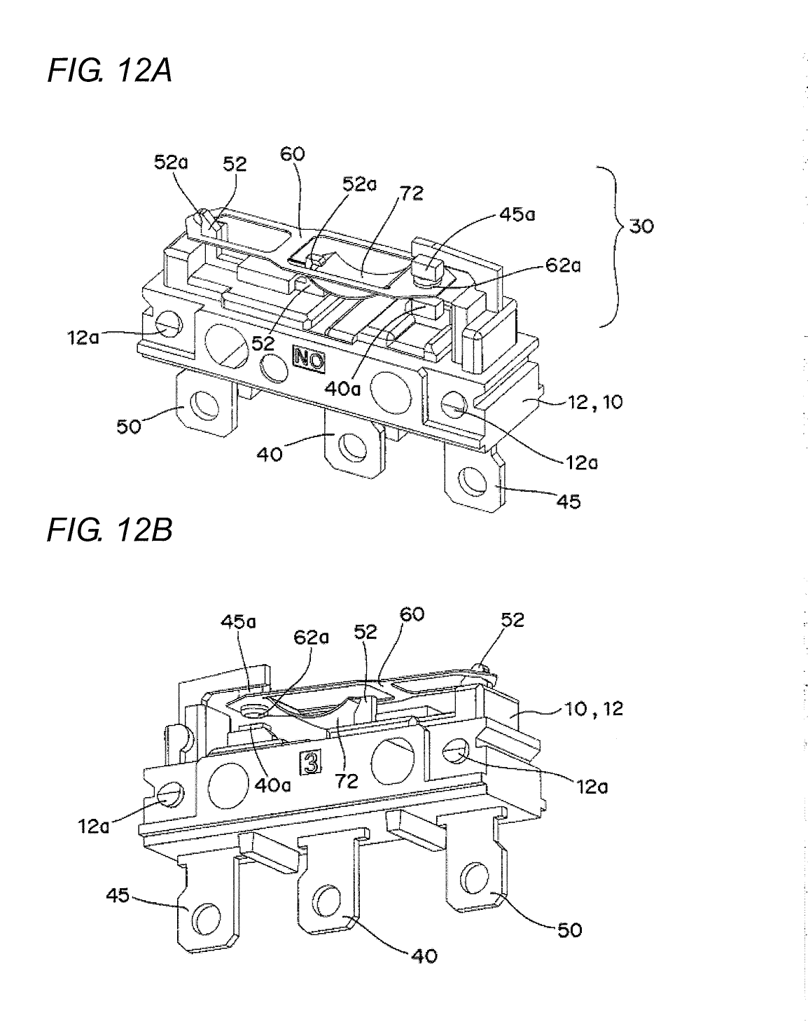

First, as shown in FIG. 10, an inner side edge of the fit-in hole 62b of the movable contact piece 60 is locked to the lock receiving portion 52a of the projection piece 52 on one side projecting out from the base 12, and the lock portion 72a of the plate spring 72 is locked to the lock receiving portion 52b of the projection piece 52 on the other side. The movable contact 62a is thus positioned between the always-opened fixed contact 40a and the always-closed fixed contact 45a, and is biased to the upper side (FIGS. 12A, 12B).

The cover 13 in which the operating element 20 is assembled to the operation hole 13a is fitted into the base 12, and the engagement nail portion 12a of the base 12 is engaged and integrated with the engagement hole 13c of the cover 13. The lower end of the operating element 20 shown in FIG. 11 is thereby brought into contact with the movable contact piece 60, and the projection 13d can be brought into contact with the plate spring 72 of the movable contact piece 60.

The operation method of the switch according one or more embodiments of the present invention will now be described.

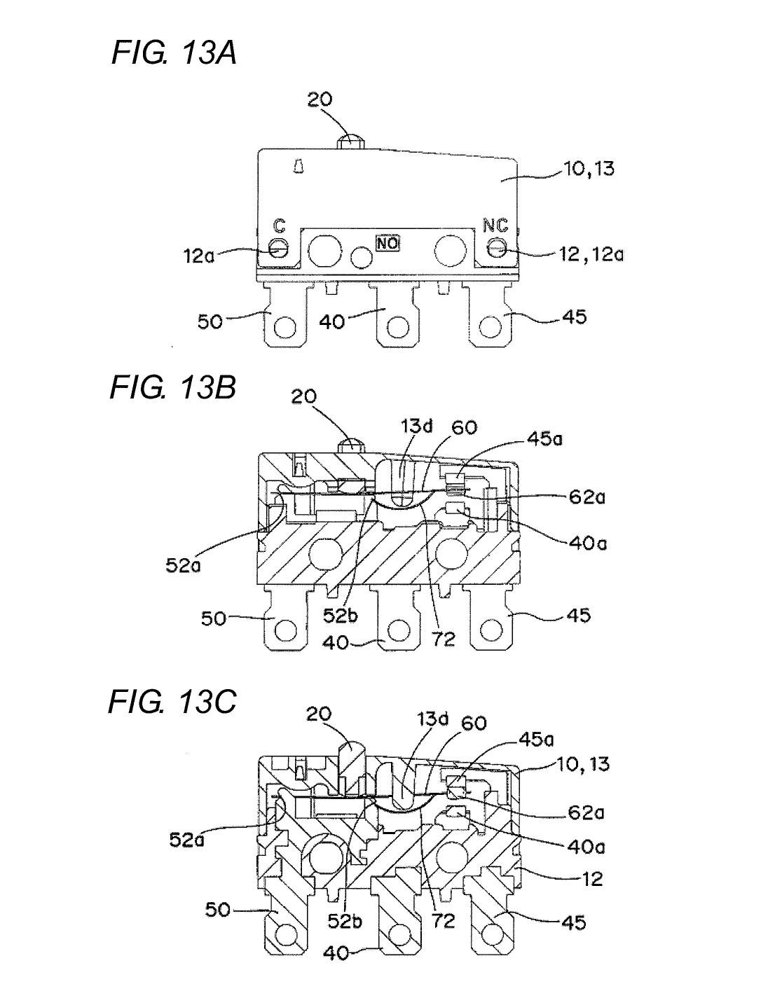

As shown in FIGS. 13A to 13C, the movable contact 62a is brought into contact with the always-closed fixed contact 45 at a predetermined contact pressure by the spring force of the plate spring 72 of the movable contact piece 60 when the operating element 20 is in the no-load state.

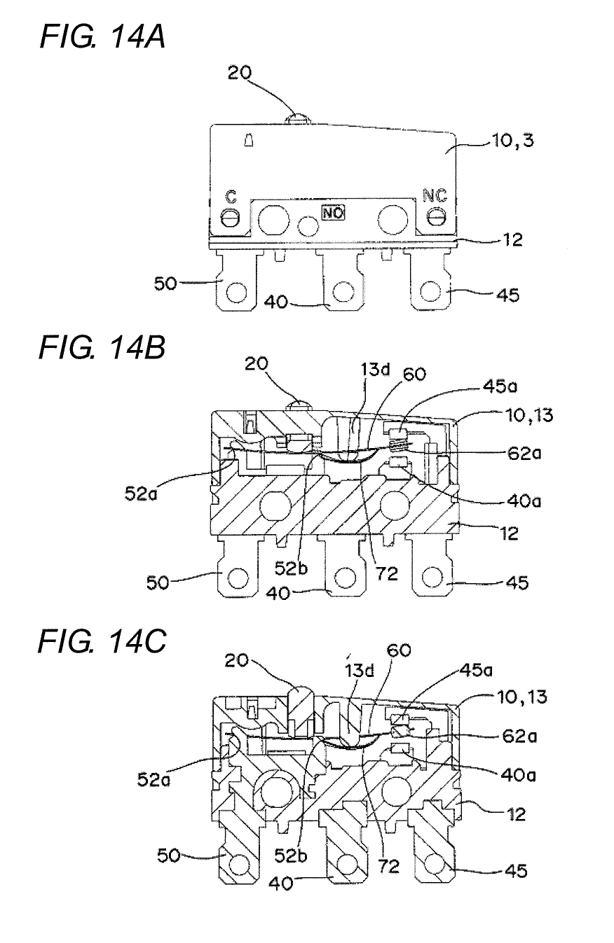

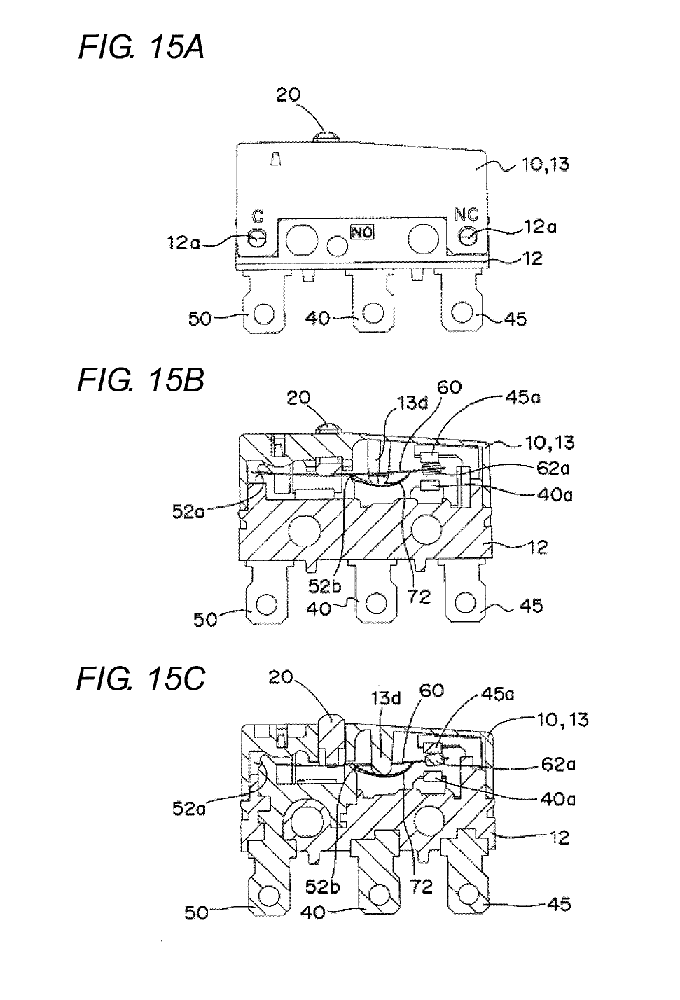

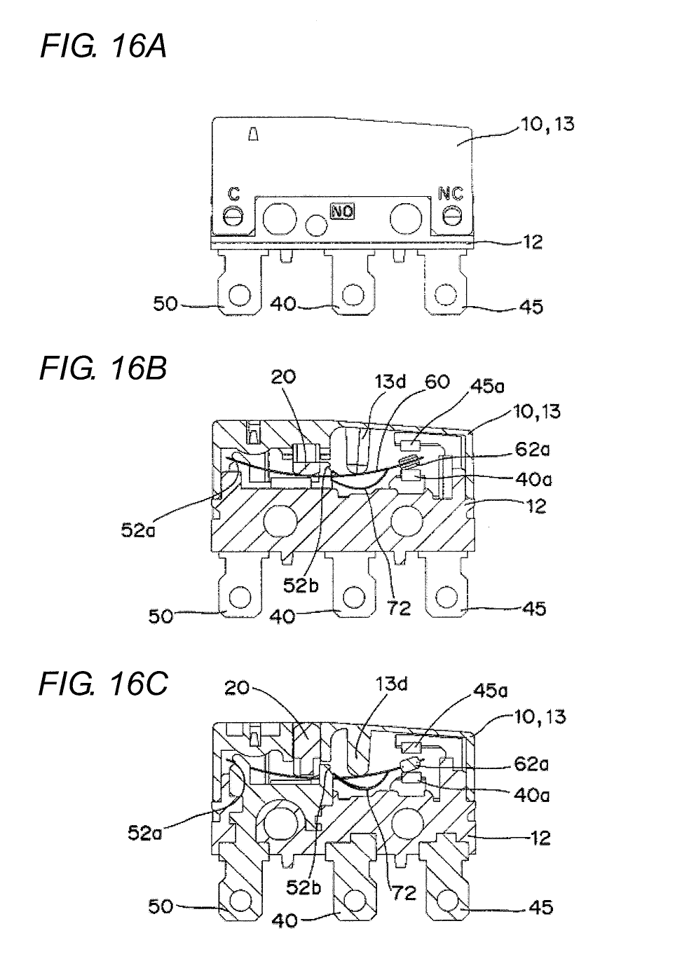

As shown in FIGS. 14A to 14C and FIGS. 15A to 15C, the movable contact piece 60 bends when the operating element 20 is pushed down. When the lower end of the operating element 20 goes over the reference line (not shown) connecting the lock receiving portions 52a, 52b of the projection pieces 52, 52, the movable contact piece 60 is inverted with the lock receiving portion 52a as a supporting point by the spring force of the plate spring 72 (FIGS. 16A to 16C). The movable contact 62a is thereby switched from the always-closed fixed contact 45a to the always-opened fixed contact 40a, and the movable contact 62a is brought into contact with the always-opened fixed contact 40 at a predetermined contact pressure by further pushing in the operating element 20.

When the load of the operating element 20 is released, the movable contact piece 60 is inverted by the spring force of the plate spring 72, and the movable contact 62a is switched from the always-opened fixed contact 40a to the always-closed fixed contact 45a to return to the original state.

The plate spring 72 elastically deforms and vibrates when the movable contact piece 60 is turned, but the position regulating projection 13d of the cover 13 is brought into contact with the plate spring 72 thus shifting the timing of increasing the amplitude and preventing the resonance phenomenon.

Similarly, the resonance phenomenon caused by the increase of the amplitude can be prevented even if an impact force is applied from the outside since the plate spring 72 is brought into contact with the projection 13d of the cover 13. In particular, the slip-out of the movable contact piece 60 can be prevented even if horizontal oscillation is applied since the distal end of the projection 13d is fitted to the movable contact piece 60.

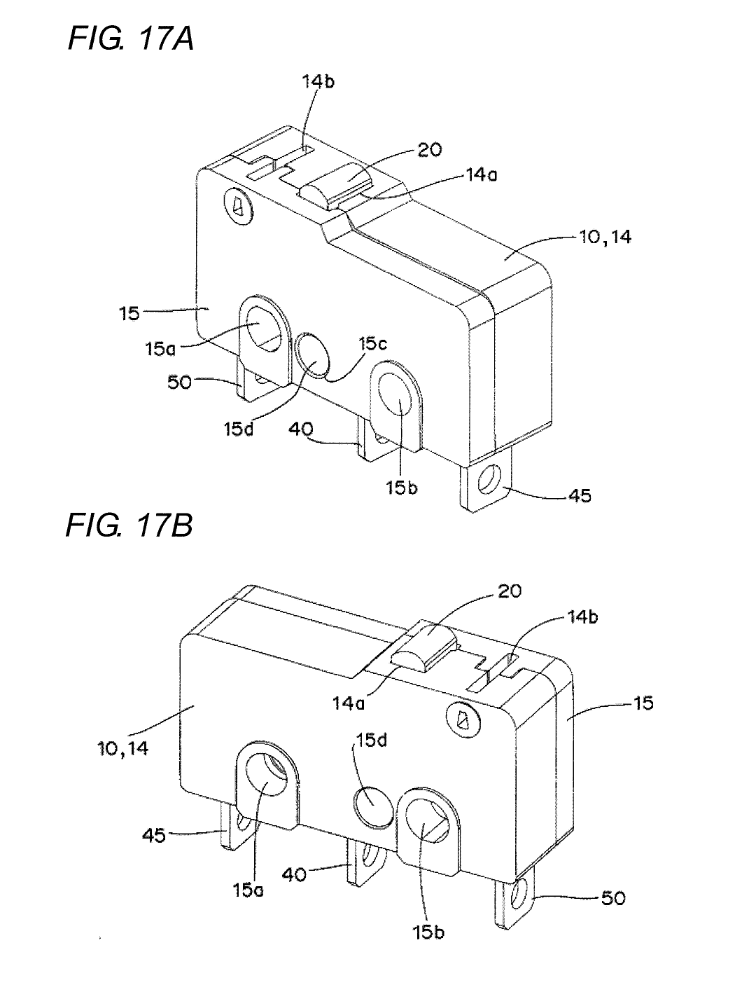

As shown in FIGS. 17A and 17B to FIGS. 24A to 24C, a switch according to a third embodiment has the contact mechanism 30 incorporated in the housing 10 formed by the base 14 and the cover 15, and has the contact mechanism 30 operable with the operating element 20 assembled to the housing 10.

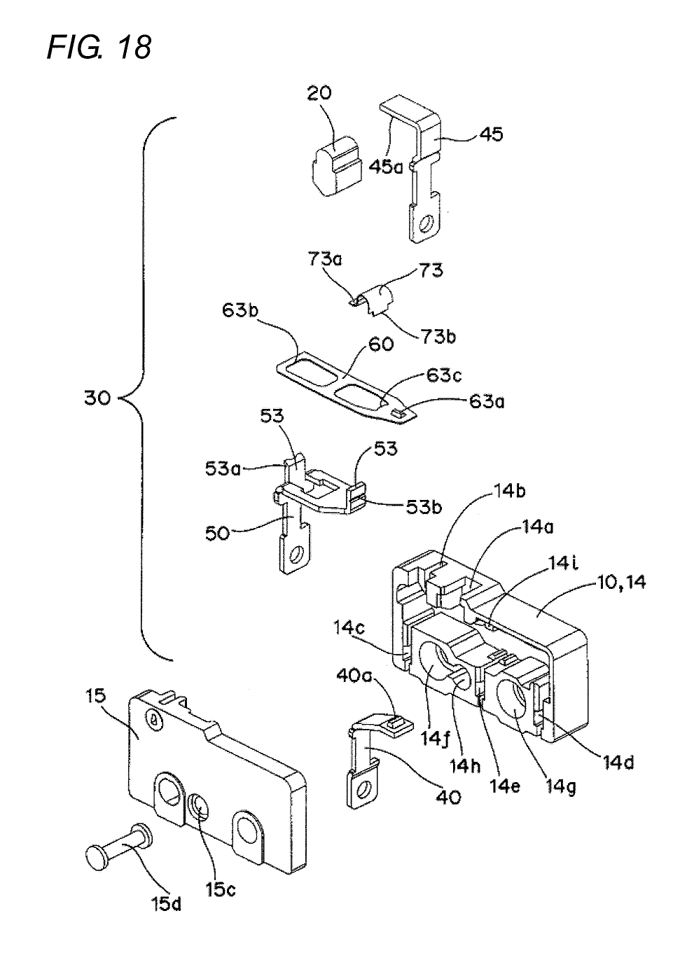

As shown in FIG. 18, the base 14 includes an operation hole 14a for assembling the operating element 20, and includes an attachment hole 14b for assembling an operation lever (not shown) in the vicinity of the operation hole 14a. The base 10 includes slits 14c, 14d, 14e to which the common terminal 50, the always-closed fixed contact terminal 45, and the always-opened fixed contact terminal 40 can be press fit from the side. The base 10 includes a pair of attachment holes 14f, 14g, and a rivet hole 14e is formed between the attachment holes 14f, 14g. The base 10 has a projection 14i arranged in a projecting manner at the top surface.

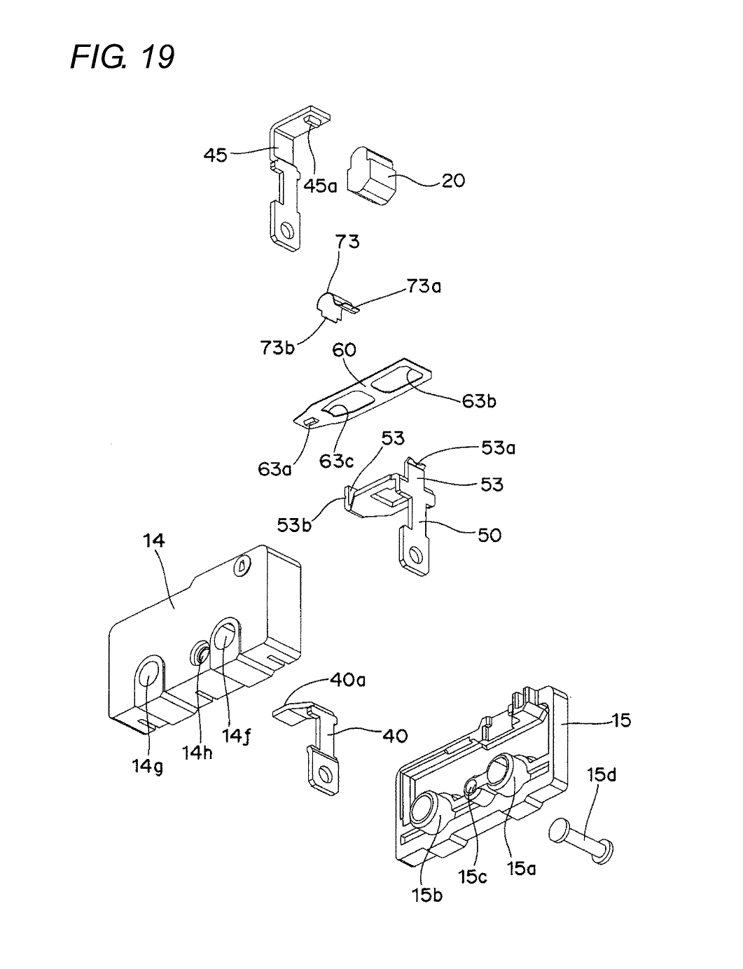

As shown in FIG. 19, the cover 15 has a side surface shape that can be fitted to the base 14, where fit-in bosses 15a, 15b are arranged at positions corresponding to the attachment holes 14f, 14f, and a rivet hole 15c is also formed.

As shown in FIG. 18, the contact mechanism 30 includes the always-opened fixed contact terminal 40 and the always-closed fixed contact terminal 45 respectively including the always-opened fixed contact 40a and the always-closed fixed contact 45a at the upper end, and the common terminal 50 for assembling the movable contact piece 60 and a curved plate spring 73.

The common terminal 50 is formed with lock receiving portions 53a, 53b on the outward surface of a pair of projection pieces 53, 53 formed by bending through press working.

The movable contact piece 60 includes a movable contact 63a at one end and is formed with a pair of play-fit holes 63b, 63c by punching out a conductive plate spring.

The plate spring 73 is formed by curving a band-shaped spring material through press working, where one end 73a and the other end 73b can be locked.

The assembly method according to the third embodiment will now be described.

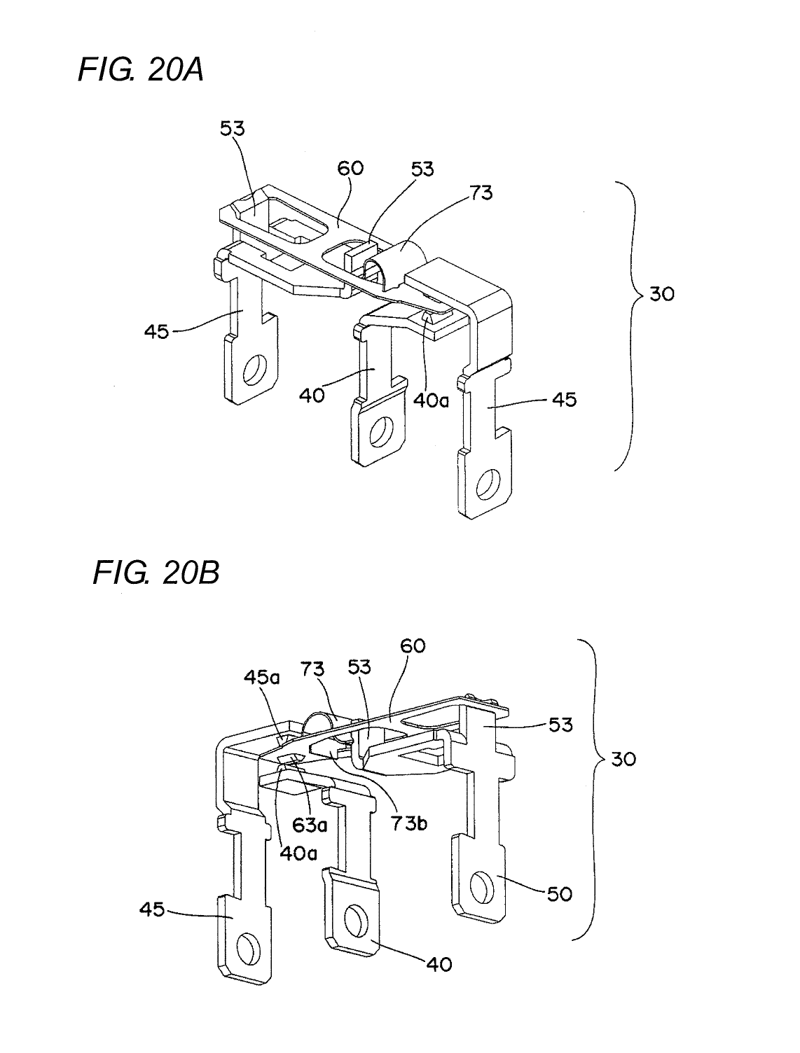

First, as shown in FIG. 18, the inner side edge of the play-fit hole 63a formed in the movable contact piece 60 is locked to the lock receiving portion 53a formed at the projection piece 53 of the common terminal 50, one end 73a of the plate spring 73 is locked to the lock receiving portion 53b formed at the projection piece 53, and the other end 73b of the plate spring 73 is locked to the inner side edge of the play-fit hole 63c (see FIGS. 20A, 20B). The common terminal 50 is then press fit and positioned in the slit 14c of the base 14 shown in FIG. 18, and the always-closed fixed contact terminal 45 and the always-opened fixed contact terminal 40 are respectively press fit and positioned in the slits 14d, 14e. The movable contact 63a is thus positioned between the always-closed fixed contact 45a and the always-opened fixed contact 40a, and is biased to the upper side. Thereafter, the operating element 20 is fitted into the operation hole 14a of the base 14, and then the positioning bosses 15a, 15b of the cover 15 are inserted to the attachment holes 14f, 14g of the base 14 shown in FIG. 19. The rivet 15d is then inserted and caulked in the rivet holes 14h, 15c, whereby the assembly task is completed.

The operation method of the switch according to the third embodiment will now be described.

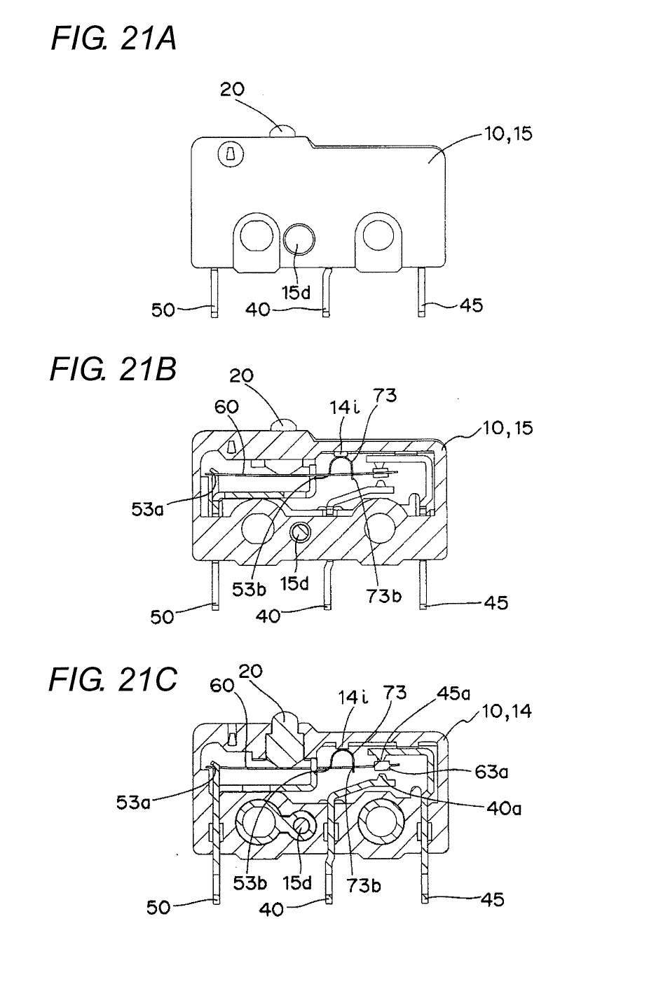

As shown in FIGS. 21A to 21C, if the operating element 20 is in the no-load state, the movable contact 63a is brought into contact with the always-closed fixed contact 45a at a predetermined contact pressure by the spring force of the plate spring 73 assembled to the movable contact piece 60.

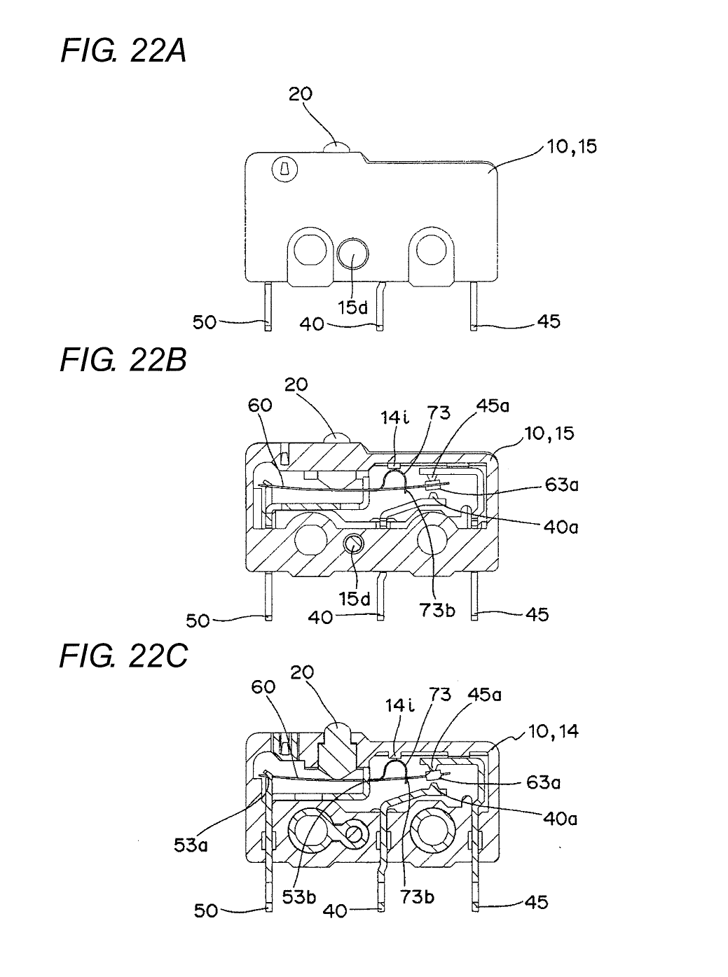

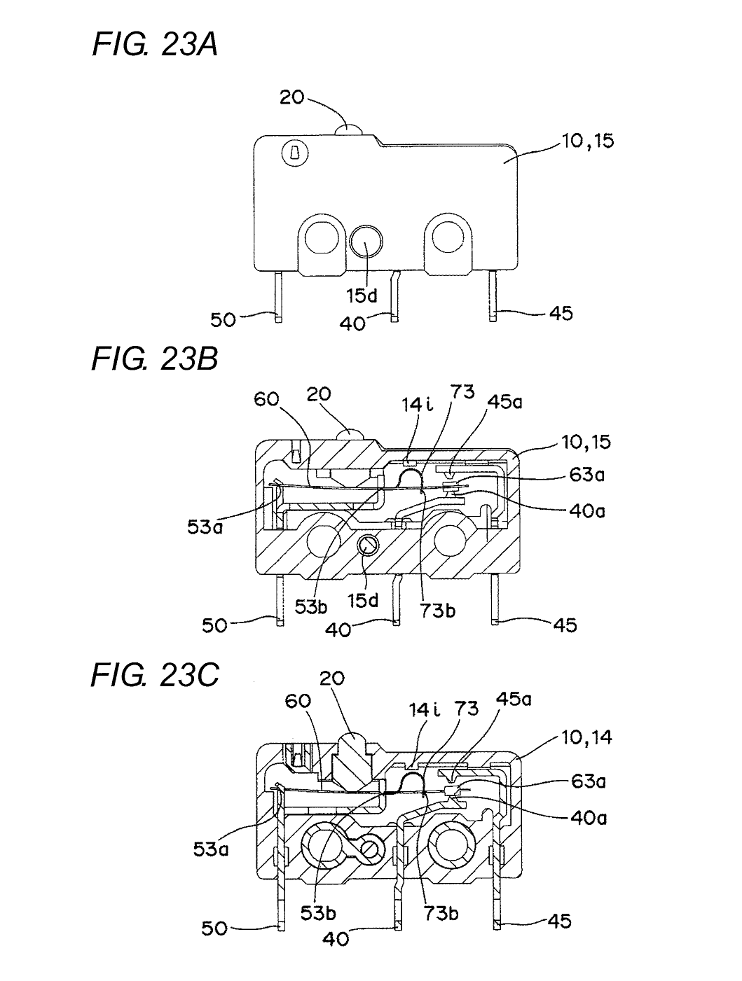

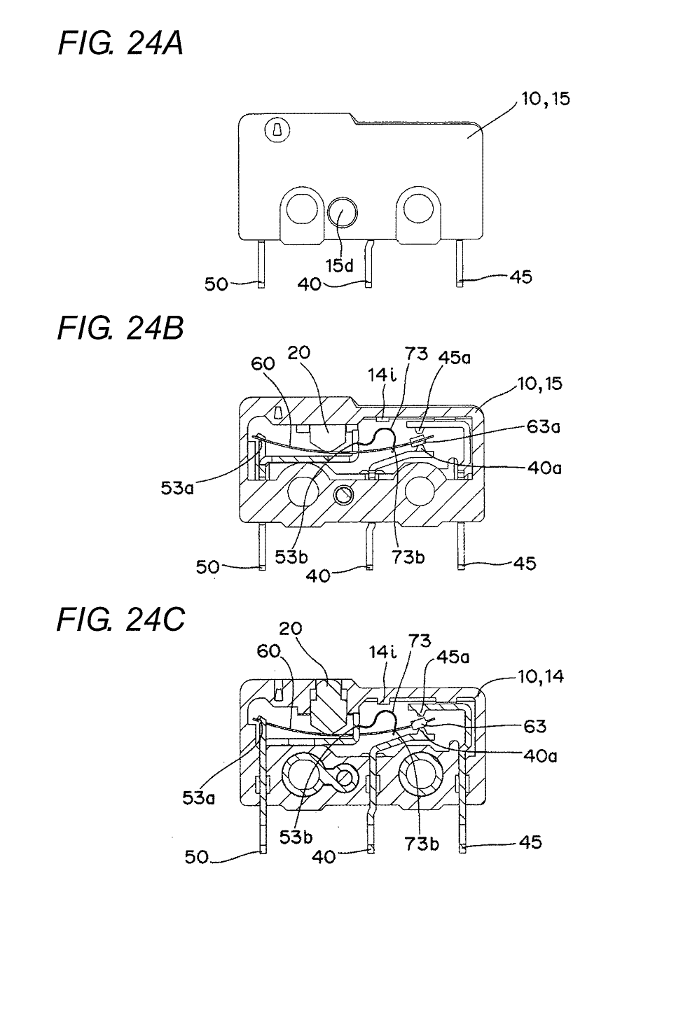

As shown in FIGS. 22A to 22C, the movable contact piece 60 bends when the operating element 20 is pushed down. When the reference line (not shown) connecting the lock receiving portion 53a of the projection piece 53 and the other end 73b of the plate spring 73 goes over the lock receiving portion 53b of the projection piece 53, the movable contact piece 60 inverts with the lock receiving portion 53a as the supporting point by the spring force of the plate spring 73 (FIGS. 23A to 23C). Therefore, the movable contact 63a switches from the always-closed fixed contact 45a to the always-opened fixed contact 40a, and when the operating element 20 is further pushed in, the movable contact 63a is brought into contact with the always-opened fixed contact 40a at a predetermined contact pressure (FIGS. 24A to 24C).

When the load of the operating element 20 is released, the movable contact piece 60 is inverted by the spring force of the plate spring 73, and the movable contact 63a is switched from the always-opened fixed contact 40a to the always-closed fixed contact 45a to return to the original state.

The plate spring 73 elastically deforms and vibrates when the movable contact piece 60 is turned, but the plate spring 73 is brought into contact with the projection 14i arranged on the base 14 thus shifting the timing of increasing the amplitude and preventing the resonance phenomenon.

Similarly, the resonance phenomenon can be prevented even if an impact force is applied from the outside since the plate spring 73 is brought into contact with the projection 14i of the cover 15.

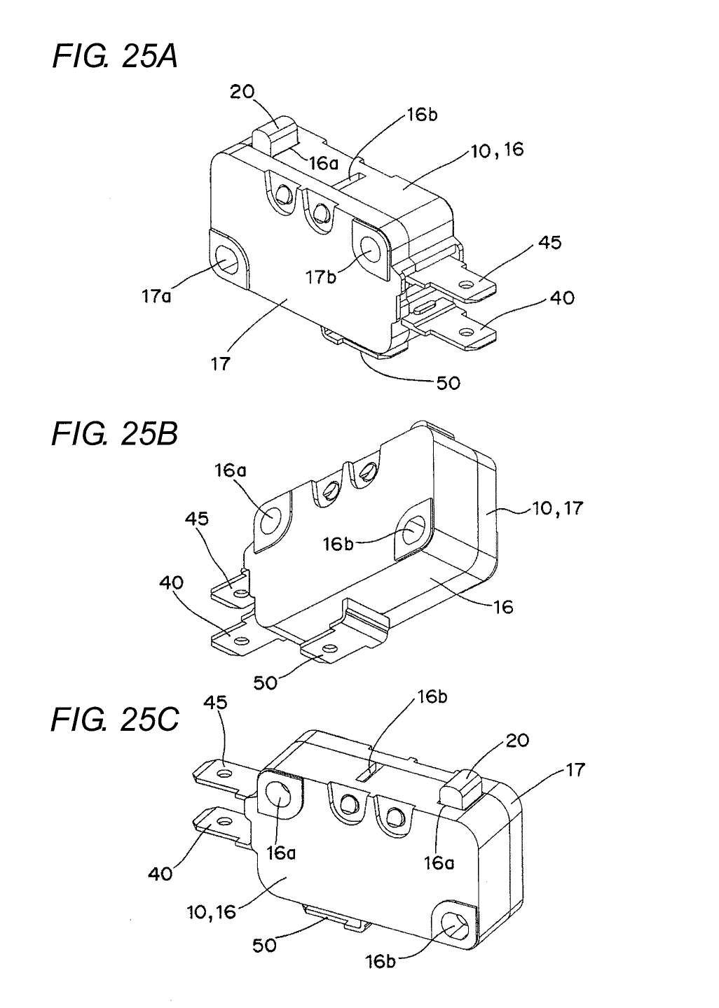

As shown in FIGS. 25A to 25C to FIGS. 32A to 32C, a switch according to a fourth embodiment has the contact mechanism 30 assembled in the housing 10 formed by a base 16 and a cover 17, by which contact mechanism 30 can be operated with the operating element 20 assembled to the housing 10.

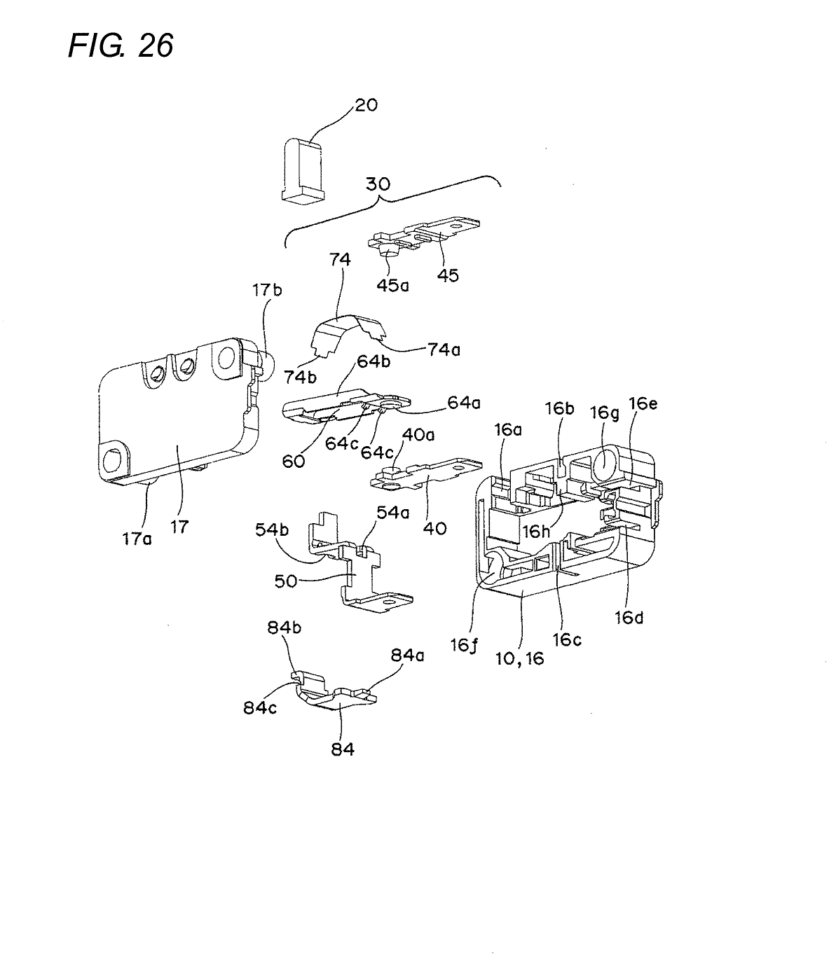

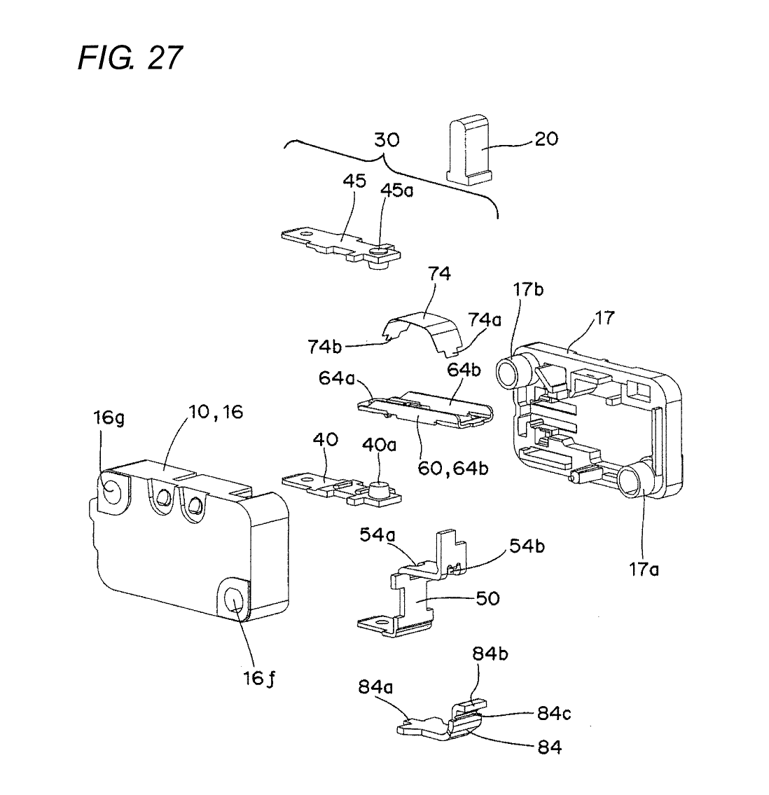

As shown in FIGS. 25A to 25C, the base 16 includes an operation hole 16a for assembling the operating element 20 at the upper surface, and a recess 16b for assembling an operation lever (not shown). As shown in FIG. 26, the base 16 includes slits 16c, 16d, 16e to which the common terminal 50, the always-opened fixed contact terminal 40, and the always-closed fixed contact terminal 45 can be press fit from the side. Furthermore, base 16 has attachment holes 16f, 16g formed at the opposing corners. A projection 16h is arranged between the operation hole 16a and the attachment hole 16g (FIG. 27).

The cover 17 has a side surface shape capable of being fitted into the base 16, and includes press-fit bosses 17a, 17b at positions corresponding to the attachment holes 16f, 16g.

As shown in FIG. 26, the contact mechanism 30 includes the common terminal 50 for assembling the movable contact piece 60, the plate spring 74, and the operation piece 84, and the always-opened fixed contact terminal 40 and the always-closed fixed contact terminal 45 having the always-opened fixed contact 40a and the always-closed fixed contact 45a arranged at one end.

The common terminal 50 is formed to a step-form through press working, and includes lock receiving portions 54a, 54b including through-holes at the corners.

The movable contact piece 60 includes a movable contact 64a at one end by punching out a conductive plate spring and is formed with reinforcement ribs 64b, 65b by bending and raising both side edges. A pair of lock nails 64c, 64c is bent and raised at the opening edge in the vicinity of the movable contact 64a of the opening edge of the movable contact piece 60.

The plate spring 74 is formed by curving a band-shaped spring material through press working, where one end 74a and the other end 74b have a lockable shape.

As shown in FIG. 27, the operation piece 84 is bent to a substantially L-shape, where a lock portion 84a is formed at the distal end of the horizontal portion, an operation receiving portion 84b is formed at the upper end of the vertical portion, and a lock receiving portion 84c is formed at the outward surface.

The assembly method according to the fourth embodiment will now be described.

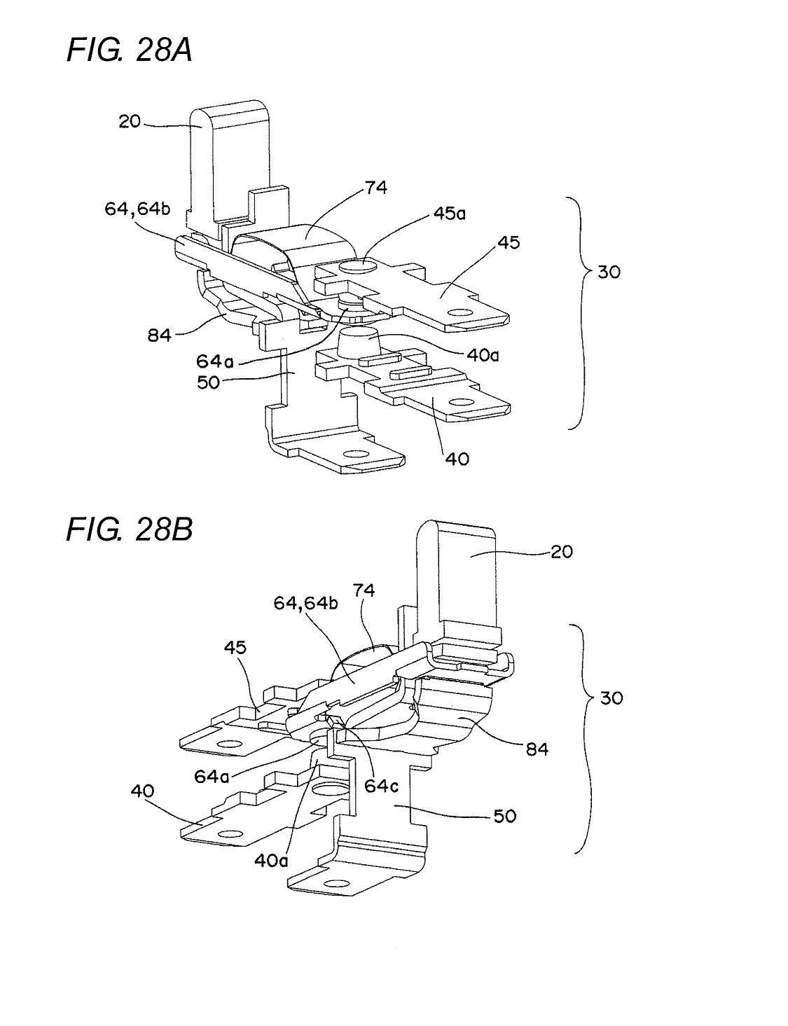

First, as shown in FIG. 26, the lock portion 84a of the operation piece 84 is locked to the lock receiving portion 54a arranged at the corner of the common terminal 50 from the lower side, and the inner side edge of the movable contact piece 60 is locked to the lock receiving portion 84c of the operation piece 84. Furthermore, one end 74a of the plate spring 74 is locked to the lock nail portions 64c, 64c of the movable contact piece 60 and one end 74b of the plate spring 74 is locked to the lock receiving portion 54b arranged at the corner of the common terminal 50 (see FIGS. 28A and 28B). The common terminal 50 is then press fit to the slit 16c of the base 16 shown in FIG. 26 for positioning, and the always-opened fixed contact terminal 40 and the always-closed fixed contact terminal 45 are respectively press fit to the slits 16d, 16e for positioning. The movable contact 64a is thus positioned between the always-opened fixed contact 40a and the always-closed fixed contact 45a, and is biased to the upper side. The operating element 20 is then fitted into and positioned in the operation hole 16a of the base 16, and thereafter, the positioning bosses 17a, 17b of the cover 17 are press fit and integrated to the operation holes 16f, 16g of the base 16 to complete the assembly task.

The operation method of the switch according to the fourth embodiment will now be described.

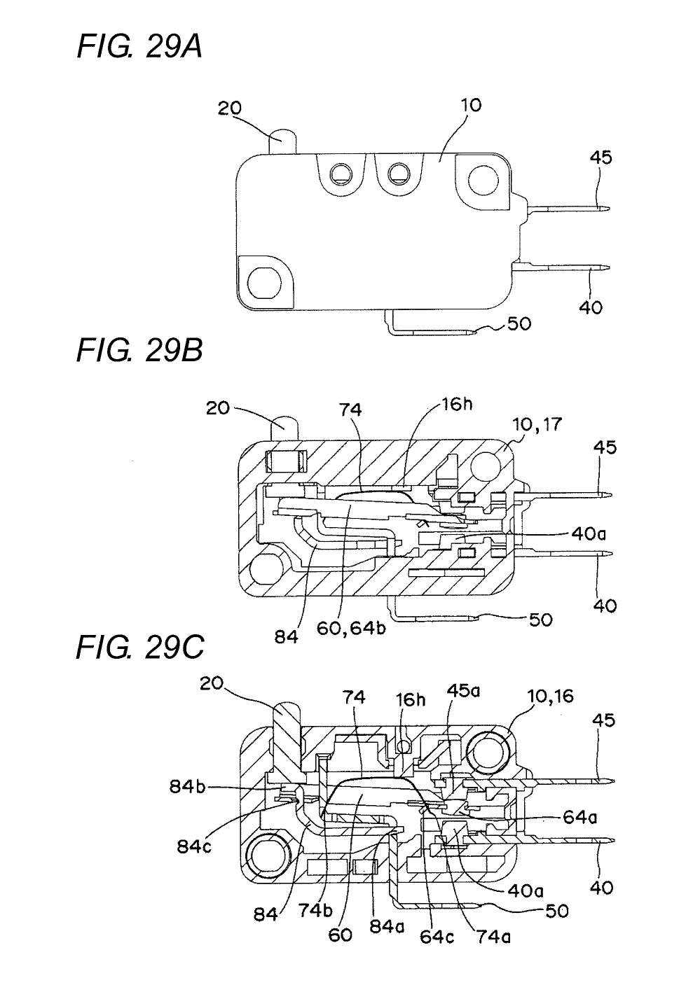

As shown in FIGS. 29A to 29C, if the operating element 20 is in the no-load state, the movable contact 64a is brought into contact with the always-closed fixed contact 45a at a predetermined contact pressure by the spring force of the plate spring 74 assembled to the movable contact piece 60.

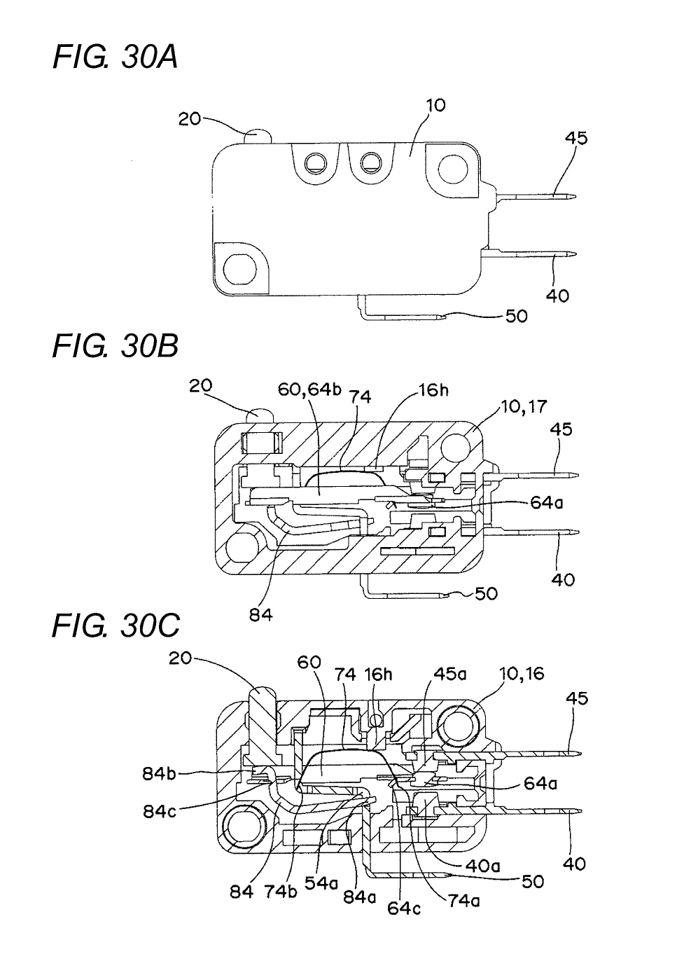

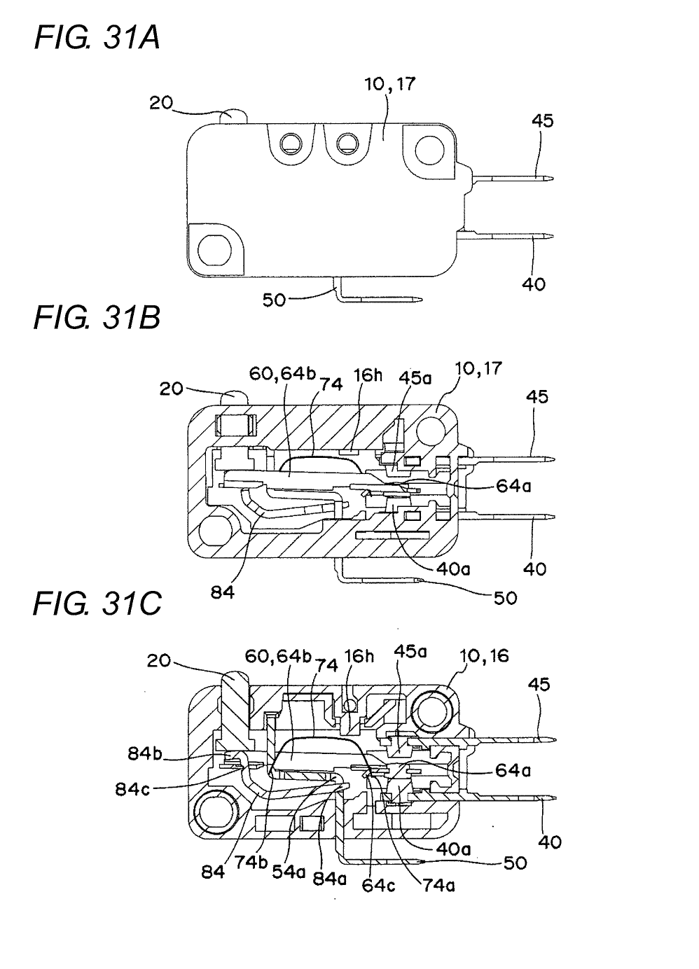

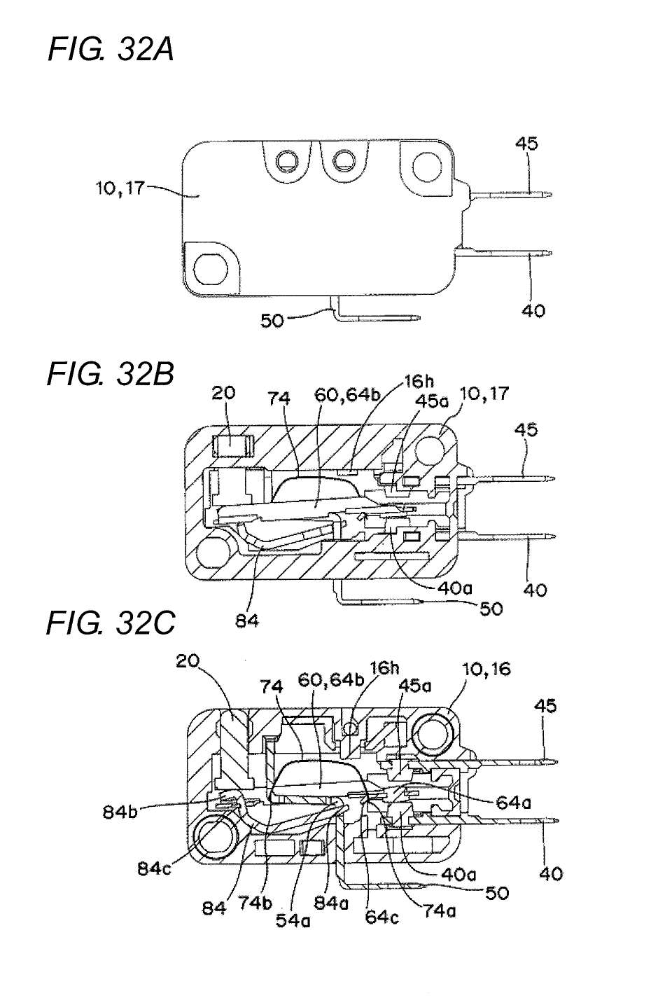

As shown in FIGS. 30A to 30C, when the operating element 20 is pushed down to push down the operation receiving portion 84b of the operation piece 84, the operation piece 84 turns with the lock portion 84a as the supporting point and the movable contact piece 60 lowers. When the reference line (not shown) connecting the lock receiving portion 84c of the operation piece 84 and the one end 74a of the plate spring 74 goes over the other end 74b of the plate spring 74, the movable contact piece 60 inverts with the lock receiving portion 84c of the operation piece 84 as the supporting point by the spring force of the plate spring 74 (FIGS. 31A to 31C). Therefore, the movable contact 64a switches from the always-closed fixed contact 45a to the always-opened fixed contact 40a. When the operating element 20 is further pushed in, the movable contact 64a is brought into contact with the always-opened fixed contact 40a at a predetermined contact pressure (FIGS. 32A to 32C).

When the load of the operating element 20 is released, the movable contact piece 60 is inverted by the spring force of the plate spring 74, and the movable contact 64a is switched from the always-opened fixed contact 40a to the always-closed fixed contact 45a to return to the original state.

The plate spring 74 elastically deforms and vibrates when the movable contact piece 60 turns, but the projection 16h arranged on the base 16 is brought into contact with the plate spring 74 thus shifting the timing of increasing the amplitude and preventing the resonance phenomenon.

Similarly, the resonance phenomenon can be prevented even if an impact force is applied from the outside since the plate spring 74 is brought into contact with the projection 16h.

### Example

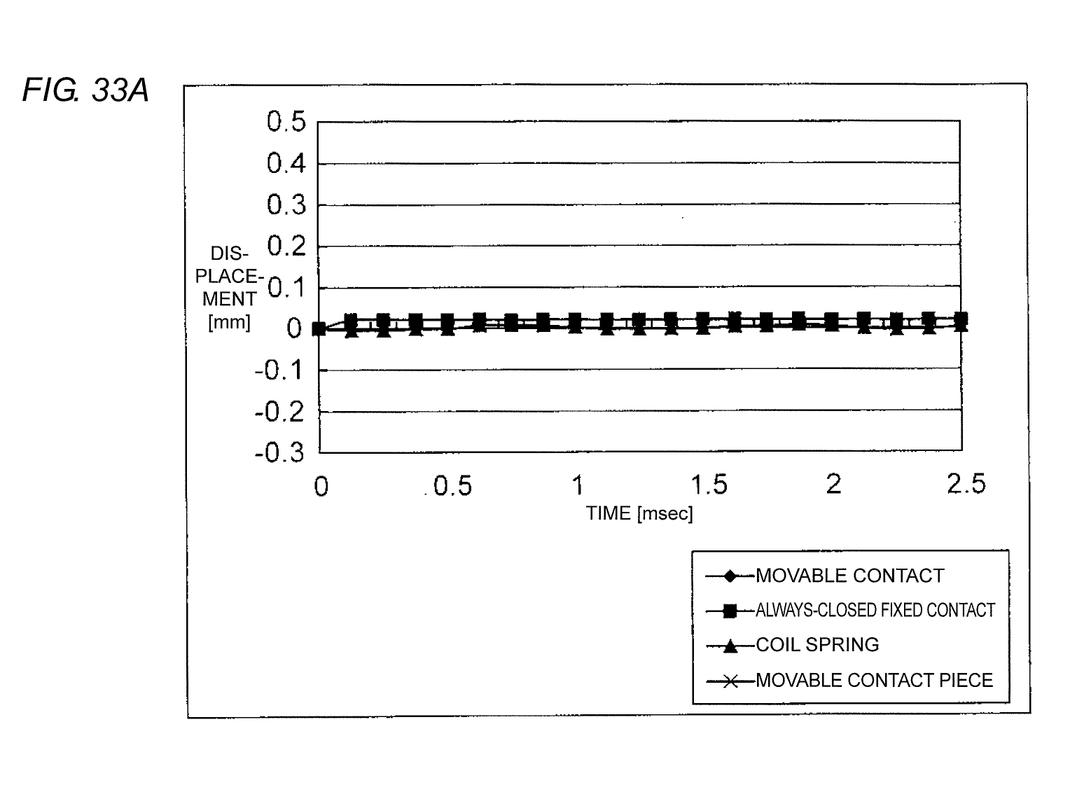

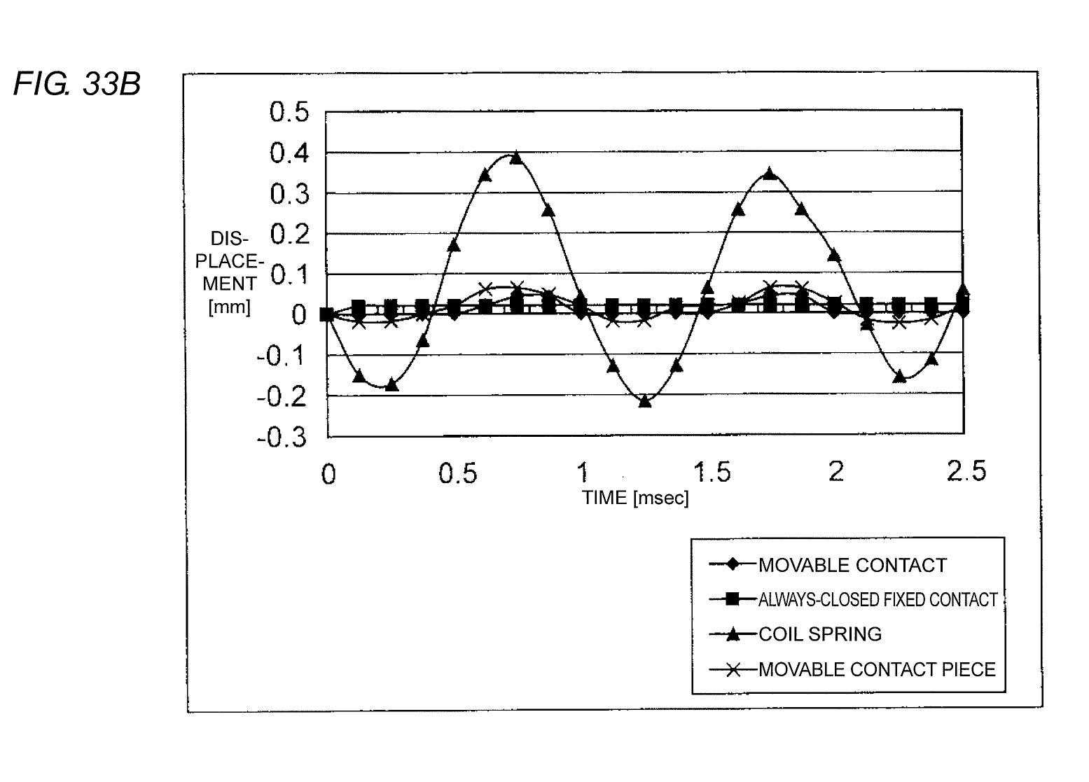

The resonance experiment was conducted using samples of the switches according to the first and second embodiments as an example. The resonance experiment was similarly conducted under the same condition using a sample of a switch in which the tongue piece is not arranged as a comparative example. The measurement results are shown in the graph of FIG. 33.

As shown in FIG. 33A, the resonance phenomenon did not occur in the coil spring in the example in which the tongue piece is arranged.

As apparent from FIG. 33B, the coil spring greatly vibrates and resonates in the comparative example in which the tongue piece is not arranged. Thus, it tends to easily break with increase in the number of stress oscillations and the lifespan also becomes shorter even if the stress amplitude width is within the elastic region. It is also recognized that the movable contact piece and the movable contact also vibrate with the resonance phenomenon of the coil spring.

According to the above experimental results, the false operation can be prevented and the lifespan can be extended by having the tongue piece inhibit the occurrence of the resonance phenomenon.

The switch according to the present invention is not limited to the above, and application may, obviously, be made on other micro-switches.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switch comprising:
a housing;
a contact mechanism having a movable contact piece disposed in the housing;
an operating element that operates the movable contact piece;
a spring member of the contact mechanism that operates the movable contact piece to open and close a contact; and
a regulating means for suppressing vibration of the spring member arranged at a position contacting the spring member.

2. The switch according to claim 1, wherein the regulating means is arranged to be brought into contact with the spring member at time of resonance.

3. The switch according to claim 1, wherein the spring member is a coil member.

4. The switch according to claim 1, wherein the spring member is a plate spring integral with the movable contact piece.

5. The switch according to claim 1, wherein the spring member is a plate spring of a separate body from the movable contact piece.

6. The switch according to claim 1, wherein the regulating means is a tongue piece cutout from a terminal of the contact mechanism.

7. The switch according to claim 1, wherein the regulating means is a projection arranged in a projecting manner on an inner surface of the housing.

8. The switch according to claim 1, wherein the regulating means is a bulging portion bulging out from an inner surface of the housing.

9. A switch comprising:
a housing;
a contact mechanism having a movable contact piece disposed in the housing;
an operating element that operates the movable contact piece;
a spring member of the contact mechanism that operates the movable contact piece to open and close a contact; and
a regulating mechanism that suppresses vibration of the spring member arranged at a position contacting the spring member.

10. The switch according to claim 9, wherein the regulating mechanism is arranged to be brought into contact with the spring member at time of resonance.

11. The switch according to claim 9, wherein the spring member is a coil member.

12. The switch according to claim 9, wherein the spring member is a plate spring integral with the movable contact piece.

13. The switch according to claim 9, wherein the spring member is a plate spring of a separate body from the movable contact piece.

14. The switch according to claim 9, wherein the regulating mechanism comprises a tongue piece cutout from a terminal of the contact mechanism.

15. The switch according to claim 9, wherein the regulating mechanism comprises a projection arranged in a projecting manner on an inner surface of the housing.

16. The switch according to claim 9, wherein the regulating mechanism comprises a bulging portion bulging out from an inner surface of the housing.
